(19) United States
(12) Patent Application Publication
(10) Pub. No.: US 2004/0199834 A1
(43) Pub. Date: Oct. 7, 2004

(54) Transceiver circuit, transceiving method, and transceiver apparatus

(76) Inventor: Fumihiro Fukae, Sakurai-shi (JP)

Correspondence Address: BIRCH STEWART KOLASCH & BIRCH, PO BOX 747, FALLS CHURCH, VA, 22040-0747, US

(21) Appl. No.: 10/761,272

(22) Filed: Jan. 22, 2004

(30) Foreign Application Priority Data
Jan. 23, 2003 (JP) 2003-015182

(51) Int. Cl. G06K 5/04

(52) U.S. Cl. 714/699

(57) ABSTRACT

A transceiver circuit comprising state machine(s) having tone phase(s) and data transfer phase(s), error detection circuit(s) detecting error(s) in receive signal(s), and phase transition suppressor circuit(s); wherein, in the event that it is determined as a result of error detection that channel quality is so poor as to make it impossible to carry out normal data transfer, transition may be made from data transfer phase(s) to tone phase(s), and by thereafter preventing transition back to data transfer phase(s) and/or speed negotiation phase(s), power consumption as would be consumed by high-speed circuit(s) when in data transfer phase(s) and/or speed negotiation phase(s) may be reduced or eliminated. Furthermore, by suppressing generation of BUS_RESET(s) due to error(s) during data transfer phase(s), reduction in bus power consumption and/or improved bus stability may be achieved.

### CROSS-REFERENCE TO RELATED APPLICATION/PRIORITY

This Nonprovisional application claims priority under 35 U.S.C. § 119(a) on Patent Application No. 2003-015182 filed in Japan on Jan. 23, 2003, the entire contents of which are hereby incorporated by reference.

### BACKGROUND OF INVENTION

1. Technical Field

The present invention relates to a transceiver circuit, transceiving method, and transceiver apparatus, any of which may be employed in the context of serial bus(es) permitting connection of personal computer(s), peripheral equipment for same, and/or audio/visual equipment; e.g., high-speed serial bus(es) as standardized at “IEEE Standard for a High Performance Serial Bus” published by IEEE (IEEE Std. 1394-1995) and the like.

2. Conventional Art

Description will first be made with respect to various items under IEEE Std. 1394-51995.

IEEE 1394

The IEEE 1394 standard defines data transfer at 100 Mbps (98.304 Mbps), 200 Mbps (196.608 Mbps), and 400 Mbps (393.216 Mbps), and defines this in a way that preserves compatibility of 1394 ports of higher transfer rate with respect to lower transfer rates. This creates the possibility for mixed data transfer at rates of 100 Mbps, 200 Mbps, and 400 Mbps occurring on the same network.

Furthermore, as shown in FIG. 15, the IEEE 1394 standard utilizes DS-Link (Data/Strobe Link) encoding transfer format in which transferred data is converted into two signals—data and strobe, which supplements that signal—it being possible to generate a clock by XOR-ing these two signals.

Arbitration signals at the physical layer are manifested by means of two twisted-pair pairs (TPA/TPA*, TPB/TPB*), one twisted-pair pair (TPA/TPA*) transmitting strobe (STRB_TX) and receiving data (DATA_RX). The other twisted-pair line (TPB/TPB*) transmits data (DATA_Tx) and receives strobe (STRB_RX).

The STRB_TX signal, DATA_TX signal, STRB_ENABLE signal, and DATA_ENABLE signal may be used to generate arbitration signals (ARB_A_RX, ARB_B_RX). Transmit arbitration signal values and the meanings thereof are shown in FIG. 16. Moreover, receive arbitration signals and the meanings thereof are shown in FIG. 17.

Under the IEEE 1394 specification, connection may be made using two methods: daisy-chain and branched-node. Using the daisy-chain method, up to a maximum of 16 nodes' worth of devices provided with 1394-compliant ports may be connected, the maximum distance between nodes being 4.5 m. Furthermore, through combined use of branched nodes, it is possible to configure a network capable of accepting connection of up to the specification maximum of 63 nodes (physical node addresses).

In addition, under the IEEE 1394 specification, connection and disconnection of cables while devices are operational, i.e., while power is turned ON, is permitted, automatic reconfiguration of the network occurring whenever nodes are added or removed. At such times, devices at connected nodes can be automatically recognized, IDs of connected devices and topology-being managed by the interface.

Increasing Transmission Length Under IEEE 1394

While there has been increased interest in recent years in use of the 1394-1995 standard for home networks, as the 1394-1995 specification defines a maximum metallic cable length of 4.5 m, the cable length restriction can pose an inconvenience.

Increased transmission length has therefore been attempted with OP i.LINK, IEEE 1394b, and the like, through replacement of one or more of the plurality of metallic transceivers in the 1394 physical layer circuitry with, for example, optical transceivers, and through replacement of metallic cable employed as communication channel with, for example, POF (plastic optical fiber) or other such optical fiber.

OP i.LINK

OP i.LINK replaces the metallic cable in the communication channel under IEEE 1394a-2000 with optical fiber. Serial signals sent and received between ports is modulated and demodulated in accordance with 8B/10B. Port state under OP i.LINK can be classified as being in one of the following three states.

(1) Tone phase

(2) Speed negotiation phase

(3) Data transfer phase

FIG. 18 shows transmission and reception of tone signals occurring during tone phase under OP i.LINK.

When in tone phase, mutual recognition of presence of remote devices is carried out between opposing ports through exchange of short tone pulses 1001, 1004, 1005, 1008 occurring with a cycle time of 132 ms. Receive circuits employ signal detection circuits for determining whether signals are present in communication channels, a tone being deemed to have been received if a signal is detected.

The foregoing signal detection circuits only determine whether a signal is present, and under OP i.LINK, because bidirectional communication is carried out with single-core POF, even where a receive signal has been detected it will not be possible to distinguish whether the signal is a signal that was sent by itself or a signal that was sent by a remote device. That is, a receive signal detected at a time when the local device was not transmitting is a signal that was sent by a remote device, and a signal received at a time when the local device was transmitting is a signal that was sent either by the local device or a remote device. Note that at the receive signals in the timing chart at FIG. 18, pulses transmitted by the local device are indicated by a dashed line.

Upon receipt of a preestablished number of (two in FIG. 18) tones sent by a remote device, CONNECT_DETECT goes active, a connection having been established, as respectively indicated where connections are established at reference numerals 1015 and 1018 in the timing chart. Once a connection has been established, generation of a data transfer request at node A causes TPBIAS, which indicates such fact, to go active as indicated at reference numeral 1016 in the timing chart, in response to which the next tone in the transmit signal from node A will be a long tone, as indicated at reference numeral 1009 in the timing chart.

Node B, upon receiving this long tone, recognizes that TPBIAS—representing a data transfer request from a remote device—is active, and sets BIAS_DETECT active as indicated at reference numeral 1020 in the timing chart, thus notifying the local PHY that a data transfer request has been generated by a remote PHY.

The PHY of node B, a data transfer request having been generated at the local node, sets TPBIAS active as indicated at reference numeral 1019 in the timing chart, sending a continuous signal and terminating tone phase, and making transition to speed negotiation phase. Node A, having received a continuous signal from the remote device, sets BIAS_DETECT active as indicated at reference numeral 1017 in the timing chart, thus notifying local PHY that a data transfer request has been generated by a remote device.

Furthermore, tone phase is terminated with transmission of a continuous signal and transition is made to speed negotiation phase. As described above, transmission and reception of short tones permits transition from a disconnected state to a state in which a connection is established; and moreover, transmission and reception of long tones and continuous signals makes it possible for a local device to inform a remote device of a data transfer request. The node sending the long tone becomes the parent node, and the node receiving the long tone and sending the continuous signal becomes the child node. The terms “parent node” and “child node” as used here are different from the parent nodes and child nodes determined during the TREE_ID phase under IEEE 1394. Furthermore, the cycle time of the pulses making up the short tones and long tones should be sufficiently longer than the cycle time of the pulses making up the continuous signal.

FIG. 19 shows transmission and reception of signals during speed negotiation phase under OP i.LINK.

Node A and node B are both assumed to have ports with maximum transfer rates of S200. After node A and node B have entered speed negotiation phase, first, in state B1, random data is transmitted. Furthermore, while random data is being received in state B1, synchronization of bits is accomplished by means of bit synchronizing circuitry. After a preestablished time has passed in B1, transition is made to state B2. At state B2, comparison is made between the current communication transfer rate NEGO_SPEED and the maximum transfer rate of the local port, and if the current communication transfer rate is less than the maximum transfer rate of the local port, then HIGHER_SPEED is sent. Furthermore, if the current communication transfer rate is the same as the maximum transfer rate of the local port, then KEEP_SPEED is sent.

At the signals sent and received in FIG. 19, because maximum transfer rate is assumed to be S200, node A and node B each transmit HIGHER_SPEED, as respectively indicated in the timing chart at reference numeral 2009 for node A, and at reference numeral 2012 for node B. Upon receipt of HIGHER_SPEED while in state B2, this is recognized as an attempt on the part of the opposing port to increase transfer rate, and if the local port has also sent HIGHER_SPEED then NEGO_SPEED is increased to S200 and transition is made back to state B1.

At the signals sent and received in FIG. 19, node A and node B each make transition from state B2 to state B1, as respectively indicated in the timing chart at reference numeral 2018 for node A, and at reference numeral 2022 for node B. If the maximum transfer rate had been S100, transition would have been made to state B3, where termination of speed negotiation would have been mutually confirmed, resulting in transmission of END_NEGO requesting termination of speed negotiation. Node A and node B, having, at transfer rate S200, made the transition back to state B1, again transmit random data and also carry out bit synchronization as a result of having received random data. Moreover, after a preestablished time has passed, transition is made to state B2; and this time, because NEGO_SPEED and maximum transfer rate are mutually identical, each being equal to S200, KEEP_SPEED is transmitted, requesting that transfer rate be maintained unchanged.

At the signals sent and received in FIG. 19, node A and node B each transmit KEEP_SPEED, as respectively indicated in the timing chart at reference numeral 2023 for node A, and at reference numeral 2026 for node B. Node A and node B, having received KEEP_SPEED while in state B2, confirm that the remote port is attempting to maintain transfer rate unchanged, and make transition to state B3, where termination of speed negotiation is mutually confirmed.

At the signals sent and received in FIG. 19, node A and node B each make transition from state B2 to state B3, as respectively indicated in the timing chart at reference numeral 2031 for node A, and at reference numeral 2034 for node B. In state B3, END_NEGO, requesting termination of speed negotiation, is sent.

At the signals sent and received in FIG. 19, node A and node B each transmit END_NEGO, as respectively indicated in the timing chart at reference numeral 2029 for node A, and at reference numeral 2032 for node B. In state B3, upon receipt of END_NEGO, speed negotiation is terminated and transition is made to data transfer phase D0.

At the signals sent and received in FIG. 19, node A and node B each make transition from state B3 to state D0, as respectively indicated in the timing chart at reference numeral 2037 for node A, and at reference numeral 2040 for node B. If, while in state B2 or state B3, error(s) is/are detected by an error detection circuit within the receive circuit and the NEGO_SPEED at that time is S100, then a preestablished amount of time is allowed to pass, following which speed negotiation is terminated and transition is made to tone phase. But if while in state B2 or state B3, error(s) is/are detected by the error detection circuit when at other than S100, then no further attempt at communication is made at that transfer rate, NEGO_SPEED is reduced to S100, and transition is made to state B3 by way of state B1.

During data transfer phase, data transfer is carried out at the transfer rate determined as a result of speed negotiation.

Error Processing Under OP i.LINK

Under OP i.LINK, transmission and reception of data occurs in units of 10-bit characters. The 10-bit characters are encoded in accordance with the 8B/10B encoding scheme. Present at the receive circuit is an error detection circuit and a counter called INVALID_COUNT, INVALID_COUNT being incremented by 1 every time the error detection circuit detects a receive character inconsistent with the 8B/10B table or having abnormal running disparity. Furthermore, INVALID_COUNT is decremented by 1 when normal characters are received in continuous fashion. The counter is incremented and decremented in accordance with the foregoing rule, and in the event that the counter reaches a value that is greater than or equal to some preestablished value, channel quality is determined to be poor, continuous signal transmission is stopped, and transition is made to tone phase. Furthermore, separate from INVALID_COUNT, there is a counter called PORT_ERROR which counts the number of said errors as they are detected.

The value of the PORT_ERROR counter is not decremented even when normal characters are received in continuous fashion. The timing with which short tones are transmitted by a node which has made the transition to tone phase due to occurrence of errors differs depending upon whether the node is a parent or a child as determined in tone phase, the node initiating transmission of short tones after a delay of 64 ms—this being one-half of the tone cycle—if the node is a parent node, or the node transmitting short tones immediately upon making the transition to tone phase if the node is a child node.

Suspend/Disable

Under OP i.LINK, there is a suspended state and a disabled state. When the internal signal SUSPEND goes active while in data transfer phase, transmission and reception, between opposing PORTs, of TX_SUSPEND arbitration pursuant to IEEE 1394 will, under ordinary circumstances, cause opposing PORTs to each enter a suspended state.

A PORT which is in a suspended state is in tone phase, established connections continuing to be maintained through transmission and reception of short tones. When in suspended state, because the TPBIAS signal never goes active, no long tones or continuous signal is sent; and accordingly, no transition is made to speed negotiation phase.

Moreover, if the internal signal DISABLED goes active while in any arbitrary state, a disabled state will be entered. At such time, opposing PORTs will enter suspended states. Furthermore, what happens when the internal signal DISABLED goes inactive depends upon the status of connection with the remote PORT at that time: if connection with a remote PORT is already established then transition is made to suspended state, but if connection with a remote PORT is not established then transition is made to a disconnected state.

When in disabled state, transmission and reception of tones are carried out at the PORT, and connection is established with the remote PORT; but because TPBIAS never goes active, the PORT does not make the transition to speed negotiation phase.

Note, moreover, with respect to techniques for carrying out error processing in the context of digital data communication, that there are systems which determine whether patterns of bit errors or frame errors occurring during communication represent burst-type errors or random-type errors, which determine optimum communication conditions based on such error patterns, and which send protocol signals to the transmitting device (see, e.g., Japanese Patent Application Publication Kokai No. H8-130530 (1996).

Under OP i.LINK, error detection is carried out at the receive circuit when in the speed negotiation phase and when in the data transfer phase, and if it is determined that communication channel quality is poor then transition is made to tone phase.

However, when in tone phase, because the signal detection circuit within the receive circuit only detects whether a signal is present, it being impossible to distinguish how good the quality of the communication channel might be, if the foregoing TPBIAS and BIAS_DETECT go active then there will be an immediate transition to speed negotiation phase. During speed negotiation phase, if error(s) is/are detected when in state B2 or state B3 then speed negotiation will be terminated and transition will be made back to tone phase. With communication channels of such quality, the electrical power consumed by PLL employed in operating high-speed circuitry for continuous signals during speed negotiation phase goes to waste.

Furthermore, in situations such as where errors are not detected during speed negotiation phase and transition is made to data transfer phase, but while in data transfer phase, since channel quality is poor, the foregoing INVALID_COUNT reaches the preestablished value, there will be at least two occasions when a BUS_RESET is generated: once after making the transition to data transfer phase, and once when making the transition to tone phase due to occurrence of errors. During a BUS_RESET under IEEE 1394, all bus components are made to act as repeaters and the status of all nodes as well as the logical connections that had been configured between nodes are reset, and so if channel quality between any subset of nodes is poor the fact that the entire bus must be reset is extremely inefficient.

Moreover, error detection during speed negotiation under OP i.LINK is unrelated to error detection during data transfer phase, so that where channel quality is such that errors are not detected during speed negotiation but errors are detected during data transfer phase, there are occasions where transition repeatedly loops through tone phase→speed negotiation phase→data transfer phase→tone phase, repeated transition through such states as these causing the entire bus which includes such channels to become unstable.

Furthermore, the rule for incrementing and decrementing INVALID_COUNT, which is incremented and decremented as a result of error detection during data transfer phase under OP i.LINK, is rather more stringent than is necessary to meet the minimum guaranteed error rate value under the OP i.LINK specification of 10×10⁻¹², and the conditions under which transition is made from data transfer phase to tone phase are rather more stringent than would be necessary to meet an error rate of 10×10⁻¹². What this means is that in situations such as where channel quality is slightly poor, but not poor enough to cause INVALID_COUNT to reach the preestablished value, it will not be the case that channel quality is automatically determined to be poor, with transition consequently being made to tone phase. In the case of packet transport protocols in which retransmission is not carried out, such as is the case with isochronous transfer under IEEE 1394, it is desirable that channels in which errors exist are not present on the bus.

One reason for situations such as the foregoing is that when errors are detected under OP i.LINK and transition is made from data transfer phase to tone phase, although transition is nominally made from a connected state to a disconnected state, because confirmation with respect to complete disconnection from the remote device is not carried out, it will be the case, even where channel quality is poor due to cable damage, transceiver deterioration, or the like, that communication will be reinitiated without having first improved the quality of the channel through repair or the like.

Moreover, in the patent reference cited above, no suggestion whatsoever is made with respect to art that might teach transition to a state permitting data transfer when normal data transfer is made difficult due to decreased channel quality between nodes connected by cable.

### DISCLOSURE OF INVENTION

A transceiver circuit in a first mode of the present invention is capable of transferring data at one or more transfer rates, the transceiver circuit comprising one or more state machines having one or more tone phases in which determination of the maximum transfer rate for one or more channels and one or more connections with one or more remote devices is carried out through exchange of one or more tone signals with at least one of the remote device or devices, and one or more data transfer phases in which data transfer is carried out at one or more frequencies higher than that of at least one of the tone signal or signals; one or more error detection circuits detecting one or more errors (e.g., bit error and/or character error) in one or more receive signals; and one or more data transfer phase transition suppressor circuits; wherein, in the event that at least one of the error detection circuit or circuits detects at least one of the error or errors within at least one of the receive signal or signals during at least one of the data transfer phase or phases, one or more transitions is made from at least one of the data transfer phase or phases to at least one of the tone phase or phases, and after at least one of such transition or transitions has occurred, at least one of the data transfer phase transition suppressor circuit or circuits carries out control so as to prevent transition back to at least one of the data transfer phase or phases.

Because a transceiver circuit in accordance with this mode of the present invention may, in the event that it is determined while in data transfer phase(s) that channel quality is so poor as to make it impossible to carry out normal data transfer, permit transition to be made from data transfer phase(s) to tone phase(s), but thereafter permit prevention of transition back to data transfer phase(s), it is possible to achieve reduction in power consumption required for operation of high-speed circuit(s) in data transfer phase(s).

A transceiver circuit in a second mode of the present invention is similar to the transceiver circuit in the first mode of the present invention but further comprises one or more timers; and one or more error counters; wherein, only in the event that one or more numbers of errors occurring within one or more fixed times as detected by at least one of the error detection circuit or circuits, at least one of the timer or timers, and at least one of the error counter or counters during at least one of the data transfer phase or phases is greater than at least one preestablished value, one or more transitions is made from at least one of the data transfer phase or phases to at least one of the tone phase or phases, and after at least one of such transition or transitions has occurred, at least one of the data transfer phase transition suppressor circuit or circuits carries out control so as to prevent transition back to at least one of the data transfer phase or phases.

A transceiver circuit in a third mode of the present invention is similar to the transceiver circuit in the first mode of the present invention but further comprises one or more transfer rate comparison circuits comparing the minimum transfer rate of which the transceiver circuit is capable and one or more transfer rates employed during at least one of the data transfer phase or phases; wherein, only in the event that at least one of the error detection circuit or circuits detects at least one of the error or errors and at least one of the transition or transitions is made from at least one of the data transfer phase or phases to at least one of the tone phase or phases when at least one result of at least one comparison made by at least one of the transfer rate comparison circuit or circuits is that at least one of the transfer rate or rates employed during at least one of the data transfer phase or phases is identical to at least one of the minimum transfer rate or rates of which the transceiver circuit is capable, at least one of the data transfer phase transition suppressor circuit or circuits carries out control so as to prevent transition back to at least one of the data transfer phase or phases.

A transceiver circuit in a fourth mode of the present invention is capable of transferring data at one or more transfer rates, the transceiver circuit comprising one or more state machines having one or more tone phases in which one or more connections with one or more remote devices are established through exchange of one or more tone signals with at least one of the remote device or devices, one or more speed negotiation phases in which determination of the maximum transfer rate permitted by one or more channels is carried out through mutual notification of one or more transfer rates of which the local device is capable, this notification being actually carried out at at least one of such transfer rate or rates, and one or more data transfer phases in which data transfer is carried out at at least one of the transfer rate or rates determined at at least one of the speed negotiation phase or phases; one or more error detection circuits detecting one or more errors (e.g., bit error and/or character error) in one or more receive signals; and one or more speed negotiation phase transition suppressor circuits; wherein, in the event that at least one of the error detection circuit or circuits detects at least one of the error or errors within at least one of the receive signal or signals during at least one of the data transfer phase or phases, one or more transitions is made from at least one of the data transfer phase or phases to at least one of the tone phase or phases, and after at least one of such transition or transitions has occurred, at least one of the speed negotiation phase transition suppressor circuit or circuits carries out control so as to prevent transition to at least one of the speed negotiation phase or phases.

Because a transceiver circuit in accordance with such mode(s) of the present invention may, in the event that it is determined while in data transfer phase(s) that channel quality is so poor as to make it impossible to carry out normal data transfer, permit transition to be made from data transfer phase(s) to tone phase(s), but thereafter permit prevention of transition to speed negotiation phase(s), it is possible to achieve reduction in power consumption required for operation of high-speed circuit(s) in speed negotiation phase(s) and/or data transfer phase(s).

A transceiver circuit in a fifth mode of the present invention is capable of transferring data at one or more transfer rates, the transceiver circuit comprising one or more state machines having one or more tone phases in which one or more connections with one or more remote devices are established through exchange of one or more tone signals with at least one of the remote device or devices, one or more speed negotiation phases in which determination of one or more maximum transfer rates permitted by one or more channels is carried out through mutual notification of one or more transfer rates of which the local device is capable, this notification being actually carried out at at least one of such transfer rate or rates, and one or more data transfer phases in which data transfer is carried out at at least one of the transfer rate or rates determined at at least one of the speed negotiation phase or phases; one or more error detection circuits detecting one or more errors (e.g., bit error and/or character error) in one or more receive signals; and one or more speed negotiation phase transition suppressor circuits; wherein, in the event that at least one of the error detection circuit or circuits detects at least one of the error or errors within at least one of the receive signal or signals during at least one of the speed negotiation phase or phases, one or more transitions is made from at least one of the data transfer phase or phases to at least one of the tone phase or phases, and after at least one of such transition or transitions has occurred, at least one of the speed negotiation phase transition suppressor circuit or circuits carries out control so as to prevent transition to at least one of the speed negotiation phase or phases.

Because a transceiver circuit in accordance with such mode(s) of the present invention may, in the event that it is determined while in speed negotiation phase(s) that channel quality is so poor as to make it impossible to achieve normal termination of speed negotiation, permit transition to be made from data transfer phase(s) to tone phase(s), but thereafter permit prevention of transition to speed negotiation phase(s), it is possible to achieve reduction in power consumption required for operation of high-speed circuit(s) in speed negotiation phase(s).

A transceiver circuit in a sixth mode of the present invention is similar to the transceiver circuit in the fourth or fifth mode of the present invention but further comprises one or more timers; and one or more error counters; wherein, only in the event that one or more numbers of errors occurring within one or more fixed times as detected by at least one of the error detection circuit or circuits, at least one of the timer or timers, and at least one of the error counter or counters is greater than at least one preestablished value, one or more transitions is made from at least one of the data transfer phase or phases to at least one of the tone phase or phases, and after at least one of such transition or transitions has occurred, at least one of the state machine phase transition suppressor circuit or circuits carries out control so as to prevent transition to at least one of the speed negotiation phase or phases.

A transceiver circuit in a seventh mode of the present invention is similar to the transceiver circuit in the fourth or fifth mode of the present invention but further comprises one or more transfer rate comparison circuits comparing minimum transfer rates of which the transceiver circuit is capable and one or more transfer rates employed during at least one of the data transfer phase or phases; wherein, only in the event that at least one of the error detection circuit or circuits detects at least one of the error or errors and at least one of the transition or transitions is made from at least one of the data transfer phase or phases to at least one of the tone phase or phases when at least one result of at least one comparison made by at least one of the transfer rate comparison circuit or circuits is that at least one of the transfer rate or rates employed during at least one of the data transfer phase or phases is identical to at least one of the minimum transfer rate or rates of which the transceiver circuit is capable, at least one of the speed negotiation phase transition suppressor circuit or circuits carries out control so as to prevent transition to at least one of the speed negotiation phase or phases.

A transceiver circuit in an eighth mode of the present invention is similar to the transceiver circuit in the fourth or fifth mode of the present invention but further comprises one or more counters; and one or more timers; wherein the transceiver circuit is OP i.LINK-compliant; wherein at least one of the counter or counters counts one or more numbers of transitions from at least one of the tone phase or phases to at least one of the speed negotiation phase or phases; and wherein, in the event that at least one of the number or numbers of transitions as counted by at least one of the counter or counters reaches at least one preestablished value within at least one fixed time, it being determined that channel quality is poor, at least one of the speed negotiation phase transition suppressor circuit or circuits carries out control so as to prevent transition to at least one of the speed negotiation phase or phases.

A transceiver circuit in a ninth mode of the present invention is similar to the transceiver circuit in the second, third, sixth, seventh, or eighth mode of the present invention but one or more tone signal transmit select circuits are employed as at least one of the data transfer phase transition suppressor circuit or circuits or speed negotiation phase transition suppressor circuit or circuits; and in the event that at least one of the error detection circuit or circuits determines that channel quality is poor and one or more transitions is made from at least one of the data transfer phase or phases to at least one of the speed negotiation phase or phases, at least one of the tone signal transmit select circuit or circuits carries out control so as to prevent transmission of one or more tone signals.

A transceiver circuit in a tenth mode of the present invention is similar to the transceiver circuit in the ninth mode of the present invention but further comprises one or more receive signal detection circuits; and one or more timers; wherein, in the event that at least one of the receive signal detection circuit or circuits and at least one of the timer or timers establish during at least one of the tone phase or phases that at least one receive signal, being absent for not less than at least one fixed time, has been completely disconnected, at least one of the tone signal transmit select circuit or circuits reinitiates transmission of one or more tone signals.

A transceiver circuit in an eleventh mode of the present invention is similar to the transceiver circuit in the ninth mode of the present invention but further comprises one or more cable connect detection circuits; wherein, in the event that at least one of the cable connect detection circuit or circuits establishes during at least one of the tone phase or phases that one or more cables has been disconnected, at least one of the tone signal transmit select circuit or circuits reinitiates transmission of one or more tone signals after at least one of the cable or cables has been reconnected.

A transceiver circuit in a twelfth mode of the present invention is similar to the transceiver circuit in the second, third, sixth, seventh, or eighth mode of the present invention but one or more transmitter power supply control circuits are employed as at least one of the data transfer phase transition suppressor circuit or circuits or speed negotiation phase transition suppressor circuit or circuits; and in the event that at least one of the error detection circuit or circuits determines that channel quality is poor, one or more transitions is made to at least one of the tone phase or phases, and thereafter at least one of the transmitter power supply control circuit or circuits causes at least one power supply of at least one transmitter to be turned OFF.

A transceiver circuit in a thirteenth mode of the present invention is similar to the transceiver circuit in the twelfth mode of the present invention but further comprises one or more receive signal detection circuits; and one or more timers; wherein, in the event that at least one of the receive signal detection circuit or circuits and at least one of the timer or timers establish during at least one of the tone phase or phases that at least one receive signal, being absent for not less than at least one fixed time, has been completely disconnected, at least one of the transmitter power supply control circuit or circuits causes at least one power supply of at least one transmitter to be turned ON.

A transceiver circuit in a fourteenth mode of the present invention is similar to the transceiver circuit in the twelfth mode of the present invention but further comprises one or more cable connect detection circuits; wherein, in the event that at least one of the cable connect detection circuit or circuits establishes during at least one of the tone phase or phases that one or more cables has been disconnected, at least one of the transmitter power supply control circuit or circuits causes at least one power supply of at least one transmitter to be turned ON after at least one of the cable or cables has been reconnected.

A transceiver circuit in a fifteenth mode of the present invention is similar to the transceiver circuit in the sixth, seventh, or eighth mode of the present invention but the transceiver circuit is OP i.LINK-compliant; one or more TPBIAS mask circuits provided at one or more PORT locations is or are employed as at least one of the speed negotiation phase transition suppressor circuit or circuits; and in the event that at least one of the error detection circuit or circuits determines that channel quality is poor, one or more transitions is made to at least one of the tone phase or phases, and thereafter at least one of the TPBIAS mask circuit or circuits masks one or more TPBIAS signals from at least one PHY carries out control so as to prevent transmission of one or more long tones and/or one or more continuous signals even if at least one TPBIAS is active.

A transceiver circuit in a sixteenth mode of the present invention is similar to the transceiver circuit in the fifteenth mode of the present invention but further comprises one or more receive signal detection circuits; and one or more timers; wherein, in the event that at least one of the receive signal detection circuit or circuits and at least one of the timer or timers establish during at least one of the tone phase or phases that at least one receive signal, being absent for not less than at least one fixed time following transmission of one or more tone signals by one or more local transmit circuits, has been completely disconnected, at least one of the mask or masks applied to at least one of the TPBIAS signal or signals by at least one of the TPBIAS mask circuit or circuits is removed, causing one or more long tone signals and/or one or more continuous signals to be transmitted when at least one TPBIAS is active.

A transceiver circuit in a seventeenth mode of the present invention is similar to the transceiver circuit in the fifteenth mode of the present invention but further comprises one or more cable connect detection circuits; wherein, in the event that at least one of the cable connect detection circuit or circuits establishes during at least one of the tone phase or phases that one or more cables has been disconnected, at least one of the mask or masks applied to at least one of the TPBIAS signal or signals by at least one of the TPBIAS mask circuit or circuits is removed after at least one of the cable or cables has been reconnected, causing one or more long tone signals and/or one or more continuous signals to be transmitted when at least one TPBIAS is active.

A transceiver circuit in an eighteenth mode of the present invention is similar to the transceiver circuit in the sixth, seventh, or eighth mode of the present invention but the transceiver circuit is OP i.LINK-compliant; one or more TPBIAS suppressor circuits provided at one or more PHY locations is or are employed as at least one of the speed negotiation phase transition suppressor circuit or circuits; and in the event that at least one of the error detection circuit or circuits determines that channel quality is poor, one or more transitions is made to at least one of the tone phase or phases, and thereafter, even if at least one TPBIAS is active within at least one of the PHY location or locations, at least one of the TPBIAS suppressor circuit or circuits carries out control so as to prevent at least one of the PORT location or locations from being notified of the fact that the at least one TPBIAS is active.

A transceiver circuit in a nineteenth mode of the present invention is similar to the transceiver circuit in the eighteenth mode of the present invention but further comprises one or more receive signal detection circuits; and one or more timers; wherein, in the event that at least one of the receive signal detection circuit or circuits and at least one of the timer or timers establish during at least one of the tone phase or phases that at least one receive signal, being absent for not less than at least one fixed time following transmission of one or more tone signals by one or more local transmit circuits, has been completely disconnected, at least one of the TPBIAS suppressor circuit or circuits causes at least one of the PORT location or locations to be notified of at least one value of at least one TPBIAS signal within at least one of the PHY location or locations.

A transceiver circuit in a twentieth mode of the present invention is similar to the transceiver circuit in the eighteenth mode of the present invention but further comprises one or more cable connect detection circuits; wherein, in the event that at least one of the cable connect detection circuit or circuits establishes during at least one of the tone phase or phases that one or more cables has been disconnected, at least one of the TPBIAS suppressor circuit or circuits, after at least one of the cable or cables has been reconnected, causes at least one of the PORT location or locations to be notified of at least one value of at least one TPBIAS signal within at least one of the PHY location or locations.

A transceiver circuit in a twenty-first mode of the present invention is similar to the transceiver circuit in the sixth, seventh, or eighth mode of the present invention but the transceiver circuit is OP i.LINK-compliant; one or more BIAS_DETECT suppressor circuits provided at one or more PORT locations is or are employed as at least one of the speed negotiation phase transition suppressor circuit or circuits; and in the event that at least one of the error detection circuit or circuits determines that channel quality is poor, one or more transitions is made to at least one of the tone phase or phases, and thereafter, even if one or more long tones and/or one or more continuous signals is or are received from one or more remote devices by at least one of the PORT location or locations and at least one BIAS_DETECT is active, at least one of the BIAS_DETECT suppressor circuit or circuits carries out control so as to prevent at least one of one PHY location or locations from being notified of the fact that the at least one BIAS_DETECT is active.

A transceiver circuit in a twenty-second mode of the present invention is similar to the transceiver circuit in the twenty-first mode of the present invention but further comprises one or more receive signal detection circuits; and one or more timers; wherein, in the event that at least one of the receive signal detection circuit or circuits and at least one of the timer or timers establish during at least one of the tone phase or phases that at least one receive signal, being absent for not less than at least one fixed time following transmission of one or more tone signals by one or more local transmit circuits, has been completely disconnected, at least one of the BIAS_DETECT suppressor circuit or circuits causes at least one of the PHY location or locations to be notified of at least one value of at least one BIAS_DETECT signal within at least one of the PORT or PORTs.

A transceiver circuit in a twenty-third mode of the present invention is similar to the transceiver circuit in the twenty-first mode of the present invention but further comprises one or more cable connect detection circuits; wherein, in the event that at least one of the cable connect detection circuit or circuits establishes during at least one of the tone phase or phases that one or more cables has been disconnected, at least one of the BIAS_DETECT suppressor circuit or circuits, after at least one of the cable or cables has been reconnected, causes at least one of the PHY location or locations to be notified of at least one value of at least one BIAS_DETECT signal within at least one of the PORT location or locations.

A transceiver circuit in a twenty-fourth mode of the present invention is similar to the transceiver circuit in the sixth, seventh, or eighth mode of the present invention but the transceiver circuit is OP i.LINK-compliant; one or more BIAS_DETECT mask circuits provided at one or more PHY locations is or are employed as at least one of the speed negotiation phase transition suppressor circuit or circuits; and in the event that at least one of the error detection circuit or circuits determines that channel quality is poor, one or more transitions is made to at least one of the tone phase or phases, and thereafter, even if one or more BIAS_DETECT signals is active, masking by at least one of the BIAS_DETECT mask circuit or circuits of at least one BIAS_DETECT signal from at least one of the PORT location or locations carries out control so as to prevent at least one of the PHY location or locations to not being notified of the fact that the at least one BIAS_DETECT signal is active.

A transceiver circuit in a twenty-fifth mode of the present invention is similar to the transceiver circuit in the twenty-fourth mode of the present invention but further comprises one or more receive signal detection circuits; and one or more timers; wherein, in the event that at least one of the receive signal detection circuit or circuits and at least one of the timer or timers establish during at least one of the tone phase or phases that at least one receive signal, being absent for not less than at least one fixed time following transmission of one or more tone signals by one or more local transmit circuits, has been completely disconnected, at least one of the mask or masks applied to at least one of the BIAS_DETECT signal or signals by at least one of the BIAS_DETECT mask circuit or circuits is removed, causing at least one of the PHY location or locations to be notified of the fact that at least one BIAS_DETECT is active in the event that the at least one BIAS_DETECT is active.

A transceiver circuit in a twenty-sixth mode of the present invention is similar to the transceiver circuit in the twenty-fourth mode of the present invention but further comprises one or more cable connect detection circuits; wherein, in the event that at least one of the cable connect detection circuit or circuits establishes during at least one of the tone phase or phases that one or more cables has been disconnected, at least one of the mask or masks applied to at least one of the BIAS_DETECT signal or signals by at least one of the BIAS_DETECT mask circuit or circuits is removed after at least one of the cable or cables has been reconnected, causing at least one of the PHY location or locations to be notified of the fact that the at least one BIAS_DETECT is active in the event that the at least one BIAS_DETECT is active.

A transceiver circuit in a twenty-seventh mode of the present invention is similar to the transceiver circuit in the second, third, sixth, seventh, or eighth mode of the present invention but the transceiver circuit is IEEE 1394-compliant; one or more suspend/disable control circuits provided at one or more PHY locations is or are employed as at least one of the speed negotiation phase transition suppressor circuit or circuits; and in the event that at least one of the error detection circuit or circuits determines that channel quality is poor, at least one of the suspend/disable control circuit or circuits, during at least one of the tone phase or phases, causes at least one PORT at which at least one error is or was detected to enter at least one suspended state and/or at least one disabled state.

A transceiver circuit in a twenty-eighth mode of the present invention is similar to the transceiver circuit in the twenty-seventh mode of the present invention but further comprises one or more receive signal detection circuits; and one or more timers; wherein, in the event that at least one of the receive signal detection circuit or circuits and at least one of the timer or timers establish during at least one of the tone phase or phases that at least one receive signal, being absent for not less than at least one fixed time following transmission of one or more tone signals by one or more local transmit circuits, has been completely disconnected, at least one of the suspend/disable control circuit or circuits causes termination of at least one suspended state and/or at least one disabled state.

A transceiver circuit in a twenty-ninth mode of the present invention is similar to the transceiver circuit in the twenty-seventh mode of the present invention but further comprises one or more cable connect detection circuits; wherein, in the event that at least one of the cable connect detection circuit or circuits establishes during at least one of the tone phase or phases that one or more cables has been disconnected, at least one of the suspend/disable control circuit or circuits causes termination of at least one suspended state and/or at least one disabled state after at least one of the cable or cables has been connected.

A transceiver circuit in a thirtieth mode of the present invention is similar to the transceiver circuit in the second, third, sixth, seventh, or eighth mode of the present invention but one or more wait states is or are present between at least one of the data transfer phase or phases and at least one of the tone phase or phases; and in the event that at least one of the error detection circuit or circuits determines that channel quality is poor, one or more transitions is made from at least one of the data transfer phase or phases to at least one of the wait state or states, and only if it is established during at least one of the wait state or states that at least one remote device has been completely disconnected therefrom is at least one transition made to at least one of the tone phase or phases.

A transceiver circuit in a thirty-first mode of the present invention is similar to the transceiver circuit in the thirtieth mode of the present invention but further comprises one or more receive signal detection circuits; and one or more timers; wherein, in the event that at least one of the receive signal detection circuit or circuits and at least one of the timer or timers establish during at least one of the tone phase or phases that at least one receive signal, being absent for not less than at least one fixed time following transmission of one or more tone signals by one or more local transmit circuits, has been completely disconnected, at least one transition is made from at least one of the wait state or states back to at least one of the tone phase or phases.

A transceiver circuit in a thirty-second mode of the present invention is similar to the transceiver circuit in the thirtieth mode of the present invention but further comprises one or more cable connect detection circuits; wherein, in the event that at least one of the cable connect detection circuit or circuits establishes during at least one of the tone phase or phases that one or more cables has been disconnected, at least one transition is made from at least one of the wait state or states back to at least one of the tone phase or phases after at least one of the cable or cables has been connected.

Transceiver circuit(s) and/or transceiving method(s) in accordance with one or more modes of the present invention, where it has been established that one or more channels have been completely disconnected, permit termination or removal of suppression of transition to at least one of the speed negotiation phase or phases, thus permitting communication to be reinitiated. Furthermore, suppression of occurrence of BUS_RESET(s) following transition from speed negotiation phase(s) to data transfer phase(s) is permitted, making it possible to achieve increased bus stability.

A transceiver circuit in a thirty-third mode of the present invention is capable of transferring data at a plurality of transfer rates, the transceiver circuit comprising one or more state machines having one or more tone phases in which one or more connections with one or more remote devices are established through exchange of one or more tone signals with at least one of the remote device or devices, one or more speed negotiation phases in which determination of the maximum transfer rate permitted by one or more channels is carried out through mutual notification of one or more transfer rates of which one or more local devices is capable, this notification being actually carried out at at least one of such transfer rate or rates, and one or more data transfer phases in which data transfer is carried out at at least one of the transfer rate or rates determined at at least one of the speed negotiation phase or phases; one or more error detection circuits detecting one or more errors (e.g., bit error and/or character error) in one or more receive signals; and one or more transfer rate comparison circuits comparing the minimum transfer rate of the transceiver circuit and one or more transfer rates employed during at least one of the data transfer phase or phases; wherein, in the event that at least one of the error detection circuit or circuits detects at least one of the error or errors within at least one of the receive signal or signals during at least one of the data transfer phase or phases when at least one result of at least one comparison made by at least one of the transfer rate comparison circuit or circuits is that at least one of the transfer rate or rates employed during at least one of the data transfer phase or phases is greater than the minimum transfer rate or rates of the transceiver circuit, one or more transitions is made from at least one of the data transfer phase or phases to at least one of the tone phase or phases, and thereafter, maximum transfer rate of the transceiver circuit during at least one of the speed negotiation phase or phases is set so as to be at least one rate that is lower than at least one transfer rate employed during at least one of the data transfer phase or phases.

Because a transceiver circuit in accordance with such mode(s) of the present invention may, in the event that error(s) is/are detected in receive signal(s) by error detection circuit(s) during data transfer phase(s) when data transfer rate(s) during data transfer phase(s) is/are greater than minimum transfer rate(s) of transceiver circuit(s), cause transition to be made from data transfer phase(s) to the tone phase(s), and may thereafter cause maximum transfer rate(s) of transceiver circuit(s) during speed negotiation phase(s) to be less than transfer rate(s) in data transfer phase(s), it is possible to suppress maximum permitted transfer rate(s) following termination of speed negotiation.

A transceiver circuit in a thirty-fourth mode of the present invention is similar to the transceiver circuit in the thirty-third mode of the present invention but further comprises one or more receive signal detection circuits; and one or more timers; wherein, in the event that at least one of the receive signal detection circuit or circuits and at least one of the timer or timers establish during at least one of the tone phase or phases that at least one receive signal, being absent for not less than at least one fixed time following transmission of one or more tone signals by one or more local transmit circuits, has been completely disconnected, the at least one maximum transfer rate of the transceiver circuit during at least one of the speed negotiation phase or phases is returned to its original maximum transfer rate.

A transceiver circuit in a thirty-fifth mode of the present invention is similar to the transceiver circuit in the thirty-third mode of the present invention but further comprises one or more cable connect detection circuits; wherein, in the event that at least one of the cable connect detection circuit or circuits establishes during at least one of the tone phase or phases that one or more cables has been disconnected, the at least one maximum transfer rate of the transceiver circuit during at least one of the speed negotiation phase or phases is returned to its original maximum transfer rate after at least one of the cable or cables has been reconnected.

A transceiver circuit in a thirty-sixth mode of the present invention is similar to the transceiver circuit in the tenth or thirteenth mode of the present invention but the at least one fixed time (the at least one fixed time for establishing that at least one receive signal has been completely disconnected) is not less than 132 ms.

A transceiver circuit in a thirty-seventh mode of the present invention is similar to the transceiver circuit in the sixteenth, nineteenth, twenty-second, twenty-fifth, twenty-eighth, thirty-first, or thirty-four mode of the present invention but the at least one fixed time (the at least one fixed time for establishing that at least one receive signal has been completely disconnected) is not less than 64 ms and not more than 132 ms.

A transceiving method in a thirty-eighth mode of the present invention substantially effects manifestation of transceiver circuit(s) as in any of the first mode of the present invention through the thirty-seventh mode of the present invention.

A transceiver apparatus in a thirty-ninth mode of the present invention comprises one or more transceiver circuits substantially as in any of the first mode of the present invention through the thirty-seventh mode of the present invention; and one or more external display apparatuses; wherein, in the event that at least one of the error detection circuit or circuits determines that channel quality is poor during at least one of the data transfer phase or phases or speed negotiation phase or phases, and at least one of the transceiver circuit or circuits is in one or more suppressed states selected from among the group consisting of suppression with respect to transition to at least one of the data transfer phase or phases, suppression with respect to transition to at least one of the speed negotiation phase or phases, and suppression with respect to maximum transfer rate during at least one of the speed negotiation phase or phases, one or more users are notified of such fact by means of at least one of the external display apparatus or apparatuses.

Because a transceiver apparatus in accordance with such mode(s) of the present invention may permit external display apparatus(es) to be used to notify user(s) of status with respect to the foregoing suppression of transition to data transfer phase(s), suppression of transition to speed negotiation phase(s), suppression of maximum transfer rate(s) during speed negotiation phase(s), and/or the like, it is possible to expect that replacement of cable(s), repairs to transceiver(s), and so forth might be carried out promptly and it is possible to expect improvement in channel quality.

### BRIEF DESCRIPTION OF DRAWINGS

FIG. 1 is a block diagram showing circuit structure in a first embodiment of the present invention.

FIG. 2 is a schematic drawing showing state transitions of a PORT state machine in a first embodiment of the present invention.

FIG. 3 is a block diagram showing circuit structure in a second embodiment of the present invention.

FIG. 4 is a schematic drawing showing state transitions of a PORT state machine in a second embodiment of the present invention.

FIG. 5 is a block diagram showing circuit structure in a third embodiment of the present invention.

FIG. 6 is a block diagram showing circuit structure in a fourth embodiment of the present invention.

FIG. 7 is a block diagram showing circuit structure in a fifth embodiment of the present invention.

FIG. 8 is a block diagram showing circuit structure in a sixth embodiment of the present invention.

FIG. 9 is a block diagram showing circuit structure in a seventh embodiment of the present invention.

FIG. 10 is a block diagram showing circuit structure in an eighth embodiment of the present invention.

FIG. 11 is a block diagram showing circuit structure in a ninth embodiment of the present invention.

FIG. 12 is a block diagram showing circuit structure in a tenth embodiment of the present invention.

FIG. 13 is a schematic drawing showing state transitions of a PORT state machine in a tenth embodiment of the present invention.

FIG. 14 is a block diagram showing circuit structure in an eleventh embodiment of the present invention.

FIG. 15 is a drawing to assist in explaining DS-LINK encoding.

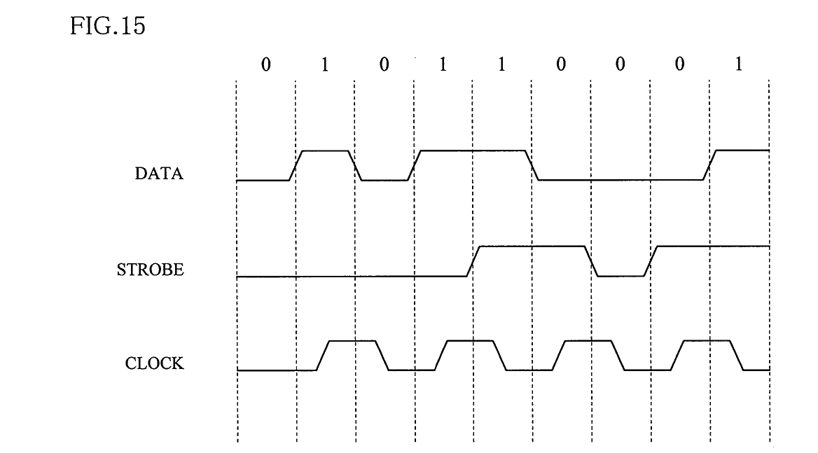

FIG. 16 is a drawing showing line states for arbitration signals transmitted at the physical layer as defined by the IEEE 1394 specification, as well as the meanings thereof.

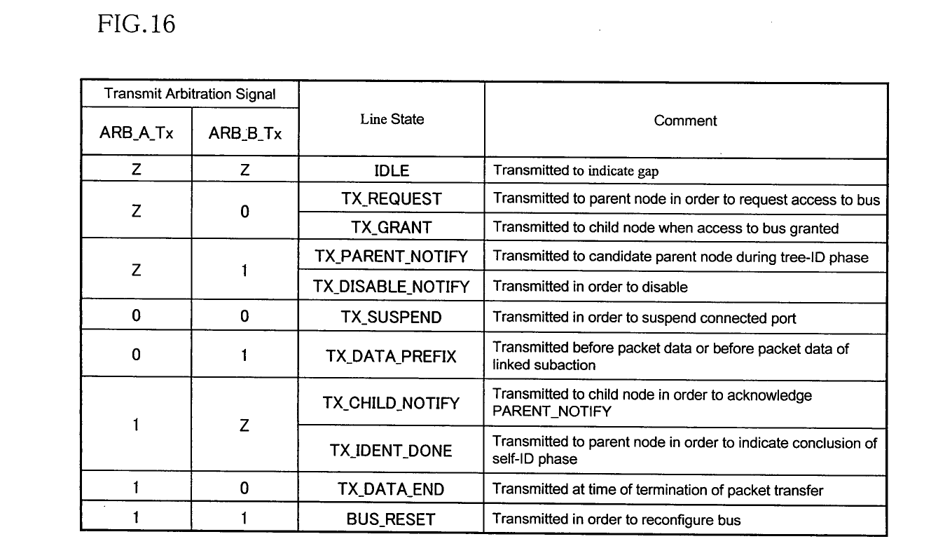

FIG. 17 is a drawing showing line states for arbitration signals received at the physical layer as defined by the IEEE 1394 specification, as well as the meanings thereof.

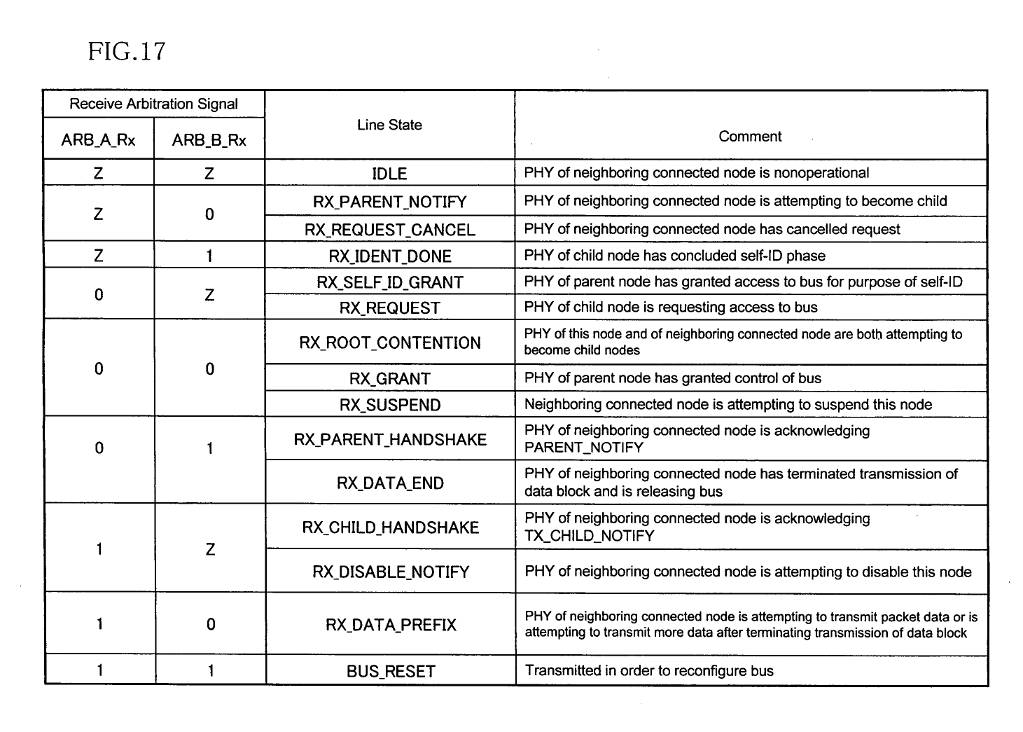

FIG. 18 is a drawing showing transmission and reception of tone signals occurring during tone phase under OP i.LINK.

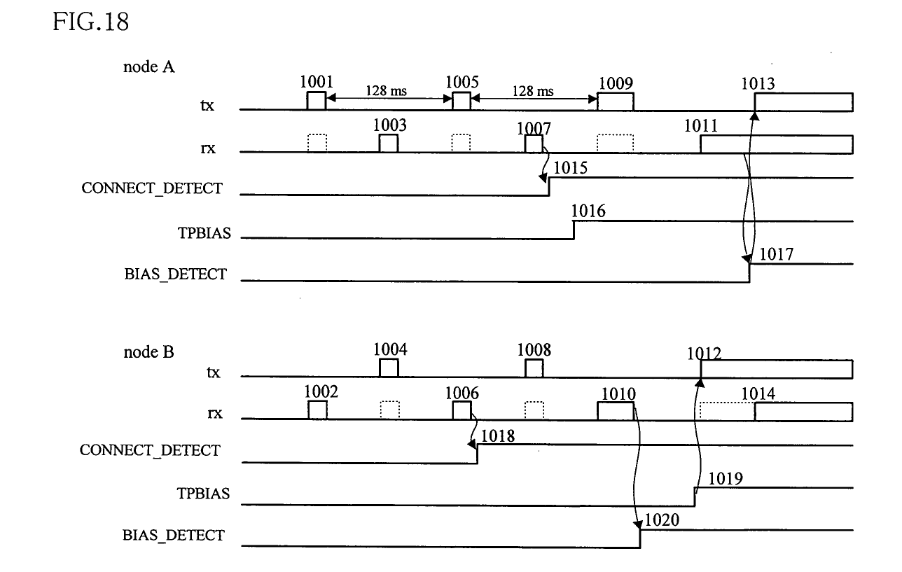

FIG. 19 is a drawing showing transmission and reception of signals occurring during speed negotiation phase under OP i.LINK.

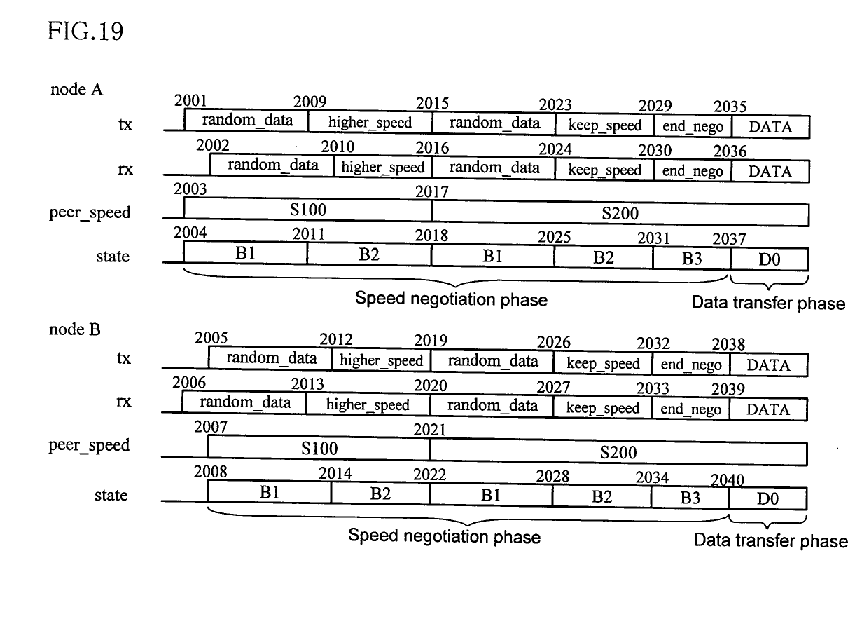

### DESCRIPTION OF PREFERRED EMBODIMENTS

Below, embodiments of the present invention are described with reference to the drawings.

Embodiment 1

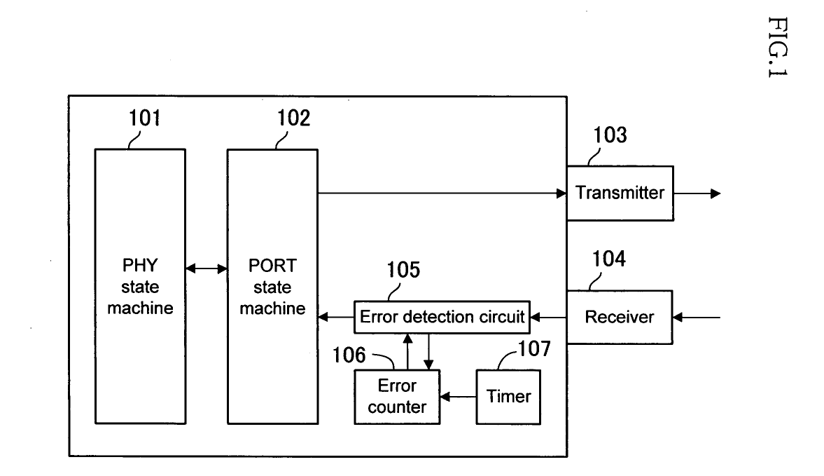

FIG. 1 is a block diagram showing circuit structure in a first embodiment of the present invention. Note that while the transceiver circuit in FIG. 1 is OP i.LINK-compliant, the present invention is not limited thereto.

The transceiver circuit in FIG. 1 comprises PHY state machine(s) 101, PORT state machine(s) 102, transmitter(s) 103, receiver(s) 104, error detection circuit(s) 105, error counter(s) 106, timer(s) 107, and so forth.

PHY state machine 101, being an IEEE 1394 PHY state machine, carries out packet transfer and arbitration in accordance with IEEE 1394.

PORT state machine 102, being an OP i.LINK-compliant PORT state machine, carries out transmission and reception of tone signals, establishing connection(s) with opposing port(s), carrying out speed negotiation, transitioning to data transfer phase upon normal termination of speed negotiation, and carrying out 8B/10B modulation of IEEE 1394-compliant arbitration signals and packets from PHY state machine 101 and sending same over cable(s) by way of transmitter 103. Furthermore, PORT state machine 102 carries out 8B/10B demodulation of receive signals received from receiver 104, and thereafter carries out error detection by means of error detection circuit 105, receive signals for which no error has been detected being output to PHY state machine 101 as IEEE 1394-compliant arbitration signals or packets.

Transmitter 103 transmits, over cable(s), OP i.LINK-compliant signals output by PORT state machine(s). Receiver 104 causes OP i.LINK-compliant signals received via cable to be input at error detection circuit 105.

Error detection circuit 105 carries out 8B/10 B demodulation of OP i.LINK-compliant receive signals received by receiver 104, incrementing the value of error counter 106 by 1 in the event that same is a character not present in the 8B/10B table and/or in the event that same is a character producing abnormal running disparity.

Error counter 106 is reset by error count reset(s) received from timer 107 and is made to increment counter value by means of detection error notification(s) received from error detection circuit 105. In the event that the value of error counter 106 reaches a preestablished value, error detection circuit 105 notifies PORT state machine 102 that, because channel quality is poor and the error rate is worse than the preestablished value therefor, transition should be made from data transfer phase to tone phase.

During data transfer phase, timer 107 is continuously engaged in counting up to some preestablished upper limit value, and in the event that timer 107 reaches the preestablished value, error counter 106 is reset. Employment of such constitution makes it possible for a user to define upper limit values for timer 107 and error counter 106 during data transfer phase, thereby permitting control of transition from data transfer phase to tone phase based on arbitrary error rate threshold(s).

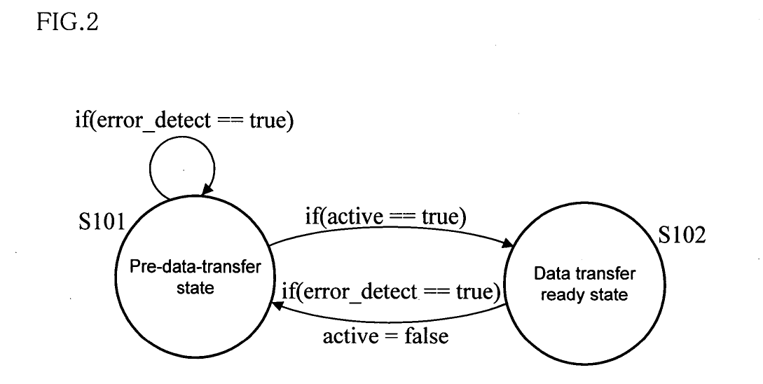

Next, referring to FIG. 2, state transitions of PORT state machine 102 are described.

State S101 is a pre-data-transfer state. Under OP i.LINK, this would correspond to tone phase and/or speed negotiation phase. State S102 is a data transfer ready state, which under OP i.LINK might correspond to data transfer phase. But note that the state machines described herein are not limited to those defined under OP i.LINK, it generally being possible to apply the present invention in the context of any communication format having pre-data-transfer state(s) and data transfer ready state(s).

At state S101, this being the pre-data-transfer state, if channel quality is good and ERROR_DETECT, controlled by error counter 106 in FIG. 1, is FALSE, then when the internal signal ACTIVE goes TRUE this will cause transition to be made to the data transfer ready state. Conversely, if ERROR_DETECT is TRUE, then transition will not be made to the data transfer ready state even if the internal signal ACTIVE goes TRUE but the state machine will instead remain in the pre-data-transfer state.

At state S 102, this being the data transfer ready state, if ERROR_DETECT goes TRUE, channel quality being determined to be poor, then the internal signal ACTIVE will be set to FALSE and transition will be made to the pre-data-transfer state. Employing such a state machine (data transfer phase transition suppressor circuit) as PORT state machine 102 makes it possible to achieve operation such that, in the event that number(s) of detected error(s) during data transfer ready state(s) are greater than or equal to preestablished value(s) and/or corresponding preestablished error rate(s), transition may be made to pre-data-transfer state(s), with transition back to data transfer ready state(s) thereafter being suppressed.

Embodiment 2

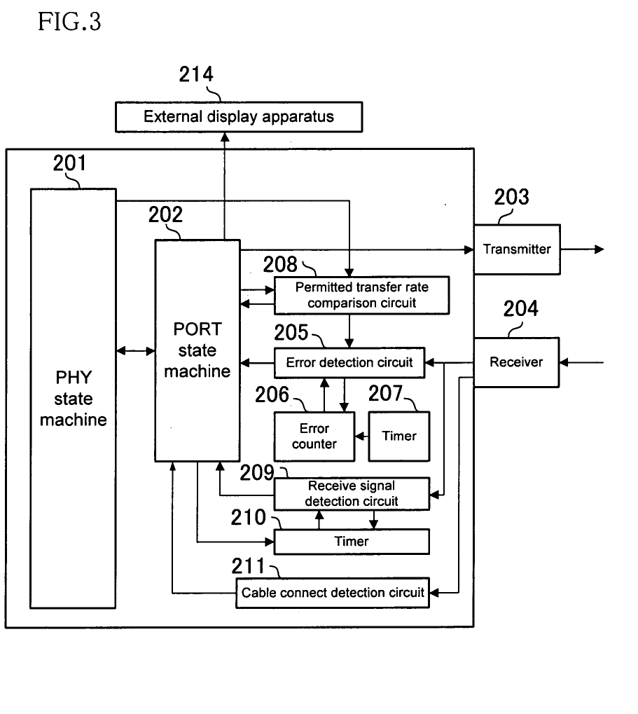

FIG. 3 is a block diagram showing circuit structure in a second embodiment of the present invention.

Characteristic of the present embodiment is that it differs from the transceiver circuit in the foregoing EMBODIMENT 1 (FIG. 1) with respect to the fact that permitted transfer rate comparison circuit(s) 208, receive signal detection circuit(s) 209, and cable connect detection circuit(s) 211 have been added, error counter reset timer(s) 207 and receive signal detection timer(s) 210 also being provided as timers; with respect to the fact that external display apparatus(es) 214 is/are connected to PORT state machine(s) 202; and with respect to the fact that operation is respectively different at PHY state machine(s) 201, PORT state machine(s) 202, permitted transfer rate comparison circuit(s) 208, and error detection circuit(s) 205. As the other components—i.e., transmitter(s) 203, receiver(s) 204, error counter(s) 206, and so forth—have functions respectively identical to those of the respective circuits described at EMBODIMENT 1, detailed description thereof will be omitted.

PHY state machine 201, being an IEEE 1394 PHY state machine, carries out packet transfer and arbitration in accordance with IEEE 1394. Furthermore, PHY state machine 201 notifies permitted transfer rate comparison circuit 208 of the minimum transfer rate of which the PORT is capable. Where S100, S200, and S400 are permitted, notification will be made with respect to S100.

PORT state machine 202, being an OP i.LINK-compliant PORT state machine, carries out transmission and reception of tone signals, establishing connection(s) with opposing port(s), carrying out speed negotiation, transitioning to data transfer phase upon normal termination of speed negotiation, and carrying out 8B/10B modulation of IEEE 1394-compliant arbitration signals and packets from PHY state machine 201 and sending same over cable(s) by way of transmitter 203. Furthermore, PORT state machine 202 carries out 8B/10B demodulation of receive signals received from receiver 204, and thereafter carries out error detection by means of error detection circuit 205, receive signals for which no error has been detected being output to PHY state machine 201 as IEEE 1394-compliant arbitration signals or packets. Moreover, following termination of speed negotiation, PORT state machine 202 notifies permitted transfer rate comparison circuit 208 of the maximum transfer rate for the channel as determined during speed negotiation.

Permitted transfer rate comparison circuit 208 compares the minimum transfer rate of which the port is capable and the maximum permitted transfer rate as determined during speed negotiation.

Moreover, operation of the present embodiment is similar to operation of the foregoing EMBODIMENT 1 but in the event that, the error rate of the channel being worse than a preestablished error rate, error counter 206 and timer 207 determine that channel quality is poor, permitted transfer rate comparison circuit 208, for example if the current maximum permitted transfer rate is identical to the minimum transfer rate of which the PORT is capable, would, after transition is made to tone phase, carry out notification so as to prevent transition to speed negotiation phase. Furthermore, if the current permitted transfer rate is greater than the minimum transfer rate of which the PORT is capable, permitted transfer rate comparison circuit 208 would carry out notification so as to cause the maximum transfer rate for the PORT to be set to a lower value during the next speed negotiation.

Receive signal detection circuit 209 detects whether receive signal(s) is/are being received at receiver 204. In the event that the receive signal is absent for a preestablished time or longer as measured by timer 210, it being determined that connection with the opposing node has been completely disconnected, PORT state machine 202 is notified of such fact.

Under OP i.LINK, in the event that the internal INVALID_COUNT reaches a preestablished value and transition is made to data transfer phase, if, based on the parent-child relationship previously established in tone phase, the local node is a parent node then it will initiate transmission of short tones after a delay of 64 ms, this being one-half of the tone cycle. But if the node is a child node, then it will transmit short tones immediately upon making the transition to tone phase. That is, except where transition has been made to tone phase as a result of errors resulting from the fact that the channel has been completely disconnected due to insertion/removal of cable(s), even where transition has been made to tone phase due to errors transmission of tone signals from the local port should be followed, after a time of from 64 ms (one-half of the tone cycle) to 132 ms (one tone cycle), by receipt of tone signals sent from the remote PORT.

An appropriate value in the foregoing range of 64 ms to 132 ms is therefore chosen, the local port transmits tone signal(s), timer 210 being reset simultaneously therewith, and in the event that the value of timer 210 reaches the chosen value (fixed time) in the range 64 ms to 132 ms with receive signal still not having been detected by receive signal detection circuit 209, this may be interpreted as meaning that the remote PORT has been completely disconnected as a result of removal of the cable or for some other similar reason. Furthermore, cable connect detection circuit 211 is capable of detecting whether the cable is unplugged at the local port, and in the event that cable connect detection circuit 211 detects that the cable is unplugged, this may be interpreted as meaning that the remote PORT has been completely disconnected therefrom.

In addition, in the present embodiment, in the event that it is established that remote PORT(s) have been completely disconnected therefrom, since there is a possibility that cable(s) might have been replaced, repairs might have been made to transceiver(s), and/or the like, PORT state machine 202 and error detection circuit 205 may be reset.

Employment of such a constitution makes it possible to achieve operation such that, in the event that error detection circuit 205 determines during data transfer phase that channel quality is poor, if the maximum permitted transfer rate at that time is identical to the minimum transfer rate of which the PORT is capable then transition is made to tone phase, with transition to speed negotiation phase being thereafter suppressed. Furthermore, if the maximum permitted transfer rate at such time is greater than the minimum transfer rate of which the PORT is capable then transition may be made to tone phase; and by thereafter, at the time of speed negotiation, causing the maximum transfer rate for the PORT to be set to a value which is lower than the maximum transfer rate from the previous speed negotiation, it is possible to suppress maximum permitted transfer rate following termination of speed negotiation.

Moreover, in the present embodiment, in the event that receive signal detection circuit 209 and/or cable connect detection circuit 211 determine that the remote PORT has been completely disconnected therefrom, it is possible by resetting PORT state machine 202 and error detection circuit 205 to return to the pre-error-detection state.

Furthermore, by using an LED, for example, or other such external display apparatus 214 to notify the user of the fact that, channel quality being poor, transition to data transfer ready state is being suppressed, it is possible to expect that channel quality might be improved as a result of replacement of cable(s), repairs to transceiver(s), and so forth.

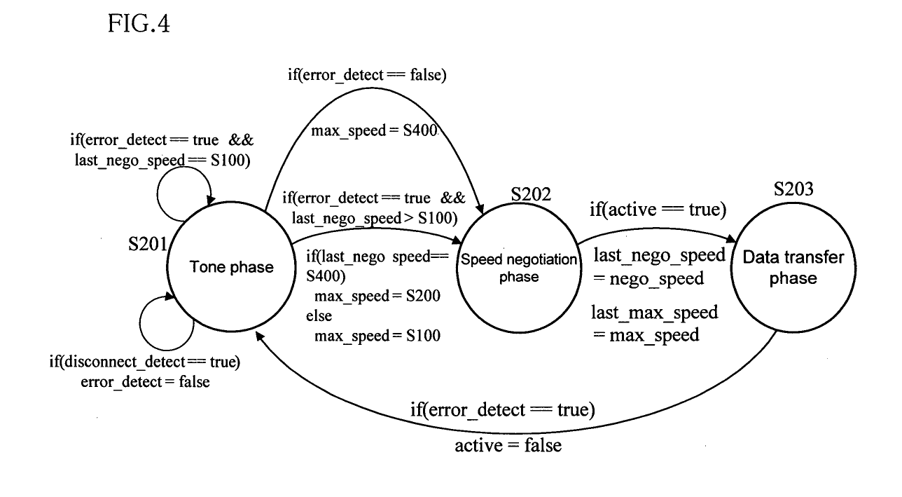

Next, referring to FIG. 4, state transitions of PORT state machine 202 of the present embodiment are described. Note, moreover, that for purposes of describing the present embodiment it will be assumed that the PORT is capable of data transfer rates of S100, S200, and S400.

During data transfer phase, the ERROR_DETECT signal is true when error rate is greater than some preestablished value. LAST_NEGO_SPEED is the maximum permitted transfer rate as determined at termination of the previous speed negotiation. LAST_MAX_SPEED is the maximum transfer rate set for the PORT by the PHY during the previous speed negotiation. MAX_SPEED is the maximum transfer rate of the PORT as set by the PHY during speed negotiation.

At state S201, this being tone phase, connection(s) with opposing port(s) is/are established as a result of transmission and reception of tone signals. If ERROR_DETECT is FALSE then MAX_SPEED is set to S400, this being the maximum transfer rate of the PORT, and transition is made to speed negotiation phase S202.

If ERROR_DETECT is FALSE then transition is made to S202, which is speed negotiation phase. If ERROR_DETECT is TRUE and LAST_NEGO_SPEED is S100 then, this being interpreted as meaning that normal communication cannot be carried out even at the minimum permitted transfer rate, transition is not made to speed negotiation phase (state S202) even after connection has been established.

On the other hand, if ERROR_DETECT is TRUE and LAST_NEGO_SPEED is greater than S100 then, it being determined that normal data transfer cannot be carried out with the maximum permitted transfer rate of the channel set to LAST_NEGO_SPEED, MAX_SPEED is lowered—to S200 if LAST_NEGO_SPEED (the previous transfer rate for the channel) is S400, or to

S100 if LAST_NEGO_SPEED is S200—thus suppressing maximum transfer rate during speed negotiation.

Furthermore, if it is established at receive signal detection circuit 209 and/or cable connect detection circuit 211 in FIG. 3 that the remote PORT has been completely disconnected therefrom then DISCONNECT_DETECT goes TRUE, causing ERROR_DETECT to go FALSE and resetting the circuitry to the regular disconnected state.

At state S202, this being the phase in which speed negotiation is carried out, NEGO_SPEED, this being the maximum permitted transfer rate with the opposing port, is determined using the MAX_SPEED set by the PHY as maximum transfer rate. NEGO_SPEED having been determined, ACTIVE goes TRUE, upon which NEGO_SPEED is written to LAST_NEGO_SPEED, MAX_SPEED is written to LAST_MAX_SPEED, and transition is made to data transfer phase.

At state S203, this being the data transfer phase, if ERROR_DETECT goes TRUE, channel quality being determined to be poor, then the internal signal ACTIVE will be set to FALSE and transition will be made to tone phase.

Employing such a state machine (speed negotiation phase transition suppressor circuit) as PORT state machine 202 makes it possible to achieve operation such that, in the event that it is determined that error rate(s) during data transfer phase(s) are greater than preestablished value(s), if the maximum permitted transfer rate at that time was the minimum transfer rate of which the PORT was capable then subsequent transition to the speed negotiation phase is suppressed, but if the maximum permitted transfer rate at that time was greater than the minimum transfer rate of which the PORT was capable then the maximum transfer rate at the time of the next speed negotiation is set to a value which is lower than the value from the previous speed negotiation, thus making it possible to suppress maximum permitted transfer rate during data transfer phase and permitting reduction in error rate.

Embodiment 3

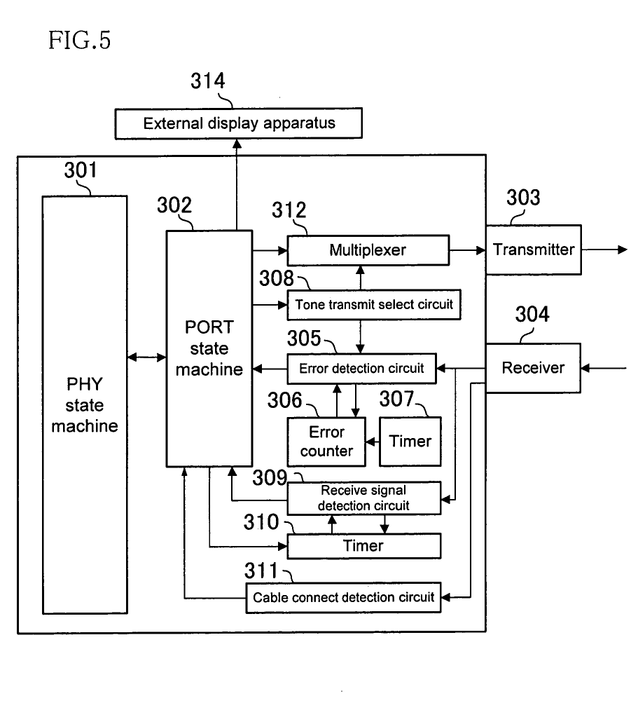

FIG. 5 is a block diagram showing circuit structure in a third embodiment of the present invention.

Characteristic of the present embodiment is that it differs from the transceiver circuit in the foregoing EMBODIMENT 2 (FIG. 3) with respect to the fact that no permitted transfer rate comparison circuit is provided but tone transmit select circuit(s) 308 and multiplexer(s) 312 have been added; and with respect to the fact that operation is respectively different at PORT state machine(s) 302 and receive signal detection timer(s) 310. As the other components—i.e., PHY state machine(s) 301, transmitter(s) 303, receiver(s) 304, error detection circuit(s) 305, error counter(s) 306, error counter reset timer(s) 307, receive signal detection circuit(s) 309, cable connect detection circuit(s) 311, and so forth—have functions respectively identical to those of the respective circuits described at EMBODIMENT 2, detailed description thereof will be omitted.

PORT state machine 302, being an OP i.LINK-compliant PORT state machine, carries out transmission and reception of tone signals, establishing connection(s) with opposing port(s), carrying out speed negotiation, transitioning to data transfer phase upon normal termination of speed negotiation, and carrying out 8B/10B modulation of IEEE 1394-compliant arbitration signals and packets from PHY state machine 301 and sending same over cable(s) by way of transmitter 303. Furthermore, PORT state machine 302 carries out 8B/10B demodulation of receive signals received from receiver 304, and thereafter carries out error detection by means of error detection circuit 305, receive signals for which no error has been detected being output to PHY state machine 301 as IEEE 1394-compliant arbitration signals or packets. In addition, in the event that, the error rate of the channel being greater than a preestablished error rate, error detection circuit 305, error counter 306, and error counter reset timer 307 determine during data transfer phase that channel quality is poor, transition is made from data transfer phase to tone phase, and tone transmit select circuit 308 is thereafter notified so as to prevent tone signals from being output to the transmitter. In response thereto, tone transmit select circuit 308 would notify multiplexer 312 that the transmit signal should be terminated, as a result of which output from multiplexer 312 would stop.

As described above, because, as a result of not sending tone signals over cable(s), establishment of connection(s) through exchange of tone signals with remote PORT(s) cannot be carried out, it is possible for circuitry to be designed such that transition is not made to speed negotiation phase(s) (for transceiving method(s) in which speed negotiation is carried out) or such that transition is not made to data transfer phase(s) (for transceiving method(s) in which speed negotiation is not carried out).

Furthermore, receive signal detection circuit 309 and timer 310 make it possible to recognize that remote PORT(s) have been completely disconnected therefrom when remote signal(s) have not been detected for a preestablished fixed time or longer. Because the local port does not transmit tone signals, it is sufficient that the foregoing fixed time be greater than or equal to 132 ms (the duration of the tone cycle), it being possible to conclude that remote PORT(s) have been completely disconnected therefrom if receive signal(s) have not been detected for 132 ms or more. Furthermore, cable connect detection circuit 311 is capable of detecting whether the cable is unplugged at the local port, and in the event that cable connect detection circuit 311 detects that the cable is unplugged, this may be interpreted as meaning that remote PORT(s) have been completely disconnected therefrom.

In accordance with the foregoing method, in the event that it is established that remote PORT(s) have been completely disconnected therefrom, since there is a possibility that cable(s) might have been replaced, repairs might have been made to transceiver(s), and/or the like, PORT state machine 302, error detection circuit 305, and tone transmit select circuit 308 may be reset, and tone signals may again be transmitted over cable(s).

Furthermore, where it has been recognized that remote PORT(s) have been completely disconnected therefrom, receive signal detection circuit 309 and/or cable connect detection circuit 311 make it possible to reinitiate transmission over cable(s) of tone signals that had been suppressed, permitting reinitiation of communication.

Furthermore, by using an LED, for example, or other such external display apparatus 314 to notify the user of the fact that, channel quality being poor, transition to data transfer ready state is being suppressed, it is possible to expect that channel quality might be improved as a result of replacement of cable(s), repairs to transceiver(s), and so forth.

Embodiment 4

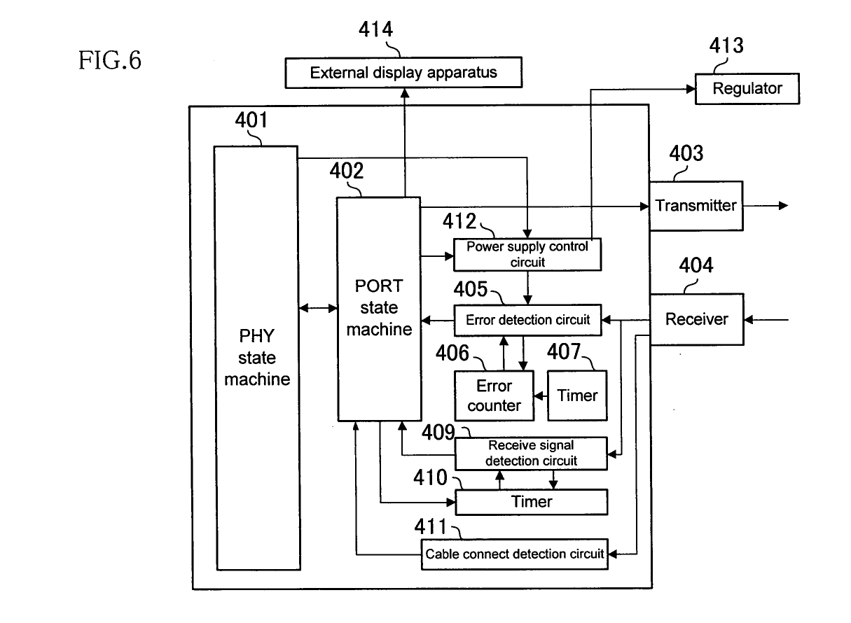

FIG. 6 is a block diagram showing circuit structure in a fourth embodiment of the present invention.

Characteristic of the present embodiment is that it differs from the transceiver circuit in the foregoing EMBODIMENT 2 (FIG. 3) with respect to the fact that no permitted transfer rate comparison circuit is provided but power supply control circuit(s) 412 and regulator(s) 413 have been added; and with respect to the fact that operation is respectively different at PORT state machine(s) 402 and receive signal detection timer(s) 410. As the other components—i.e., PHY state machine(s) 401, transmitter(s) 403, receiver(s) 404, error detection circuit(s) 405, error counter(s) 406, error counter reset timer(s) 407, receive signal detection circuit(s) 409, cable connect detection circuit(s) 411, and so forth—have functions respectively identical to those of the respective circuits described at EMBODIMENT 2, detailed description thereof will be omitted.

PORT state machine 402, being an OP i.LINK-compliant PORT state machine, carries out transmission and reception of tone signals, establishing connection(s) with opposing port(s), carrying out speed negotiation, transitioning to data transfer phase upon normal termination of speed negotiation, and carrying out 8B/10B modulation of IEEE 1394-compliant arbitration signals and packets from PHY state machine 401 and sending same over cable(s) by way of transmitter 403. Furthermore, PORT state machine 402 carries out 8B/10B demodulation of receive signals received from receiver 404, and thereafter carries out error detection by means of error detection circuit 405, receive signals for which no error has been detected being output to PHY state machine 401 as IEEE 1394-compliant arbitration signals or packets. In addition, in the event that, the error rate of the channel being greater than a preestablished error rate, error detection circuit 405, error counter 406, and error counter reset timer 407 determine during data transfer phase that channel quality is poor, transition is made from data transfer phase to tone phase, and power supply control circuit 412 is thereafter notified so as to cause the power supply at transmitter 403 to be turned OFF.

In response thereto, power supply control circuit 412 turns OFF the power supply at transmitter 403; e.g., by outputting LOW to the output control pin of regulator 413 which regulates the power supply of transmitter 403. Regulator 413 being merely one example that might be employed in connection with the power supply of transmitter 403, the present invention is not limited thereto.

Because establishment of connection(s) through exchange of tone signals with remote PORT(s) cannot be carried out due to the fact that transmitter 403 cannot send tone signals over cable(s) when its power supply is turned OFF, it is possible for circuitry to be designed such that transition is not made to speed negotiation phase(s) (for transceiving method(s) in which speed negotiation is carried out) or such that transition is not made to data transfer phase(s) (for transceiving method(s) in which speed negotiation is not carried out), making it possible to minimize waste of electrical power at transmitter 403 in situations where channel quality is poor.

Furthermore, receive signal detection circuit 409 and timer 410 make it possible to recognize that remote PORT(s) have been completely disconnected therefrom when remote signal(s) have not been detected for a preestablished fixed time or longer. Because the local port does not transmit tone signals, it is sufficient that the foregoing fixed time be greater than or equal to 132 ms (the duration of the tone cycle), it being possible to conclude that remote PORT(s) have been completely disconnected therefrom if receive signal(s) have not been detected for 132 ms or more.

Furthermore, cable connect detection circuit 411 is capable of detecting whether the cable is unplugged at the local port, and in the event that cable connect detection circuit 411 detects that the cable is unplugged, this may be interpreted as meaning that remote PORT(s) have been completely disconnected therefrom.

In accordance with the foregoing method, in the event that it is established that remote PORT(s) have been completely disconnected therefrom, since there is a possibility that cable(s) might have been replaced, repairs might have been made to transceiver(s), and/or the like, PORT state machine 402, error detection circuit 405, and power supply control circuit 412 may be reset, and, by again turning ON the power supply at transmitter 403, it will again be possible to transmit tone signals over cable(s).

Furthermore, where it has been recognized that remote PORT(s) have been completely disconnected therefrom, receive signal detection circuit 409 and/or cable connect detection circuit 411 make it possible to reinitiate transmission over cable(s) of tone signals that had been suppressed, permitting reinitiation of communication.

Furthermore, by using an LED, for example, or other such external display apparatus 414 to notify the user of the fact that, channel quality being poor, transition to data transfer ready state is being suppressed, it is possible to expect that channel quality might be improved as a result of replacement of cable(s), repairs to transceiver(s), and so forth.

Embodiment 5

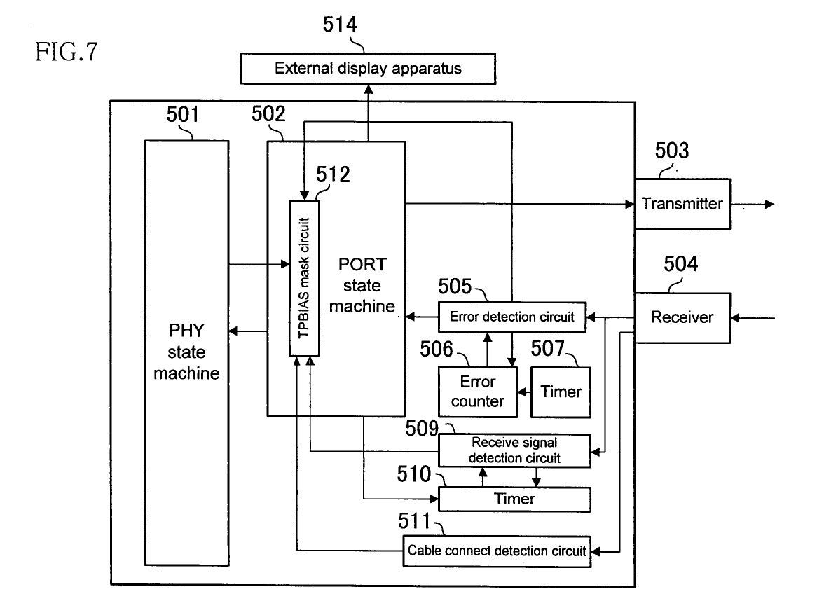

FIG. 7 is a block diagram showing circuit structure in a fifth embodiment of the present invention.

Characteristic of the present embodiment is that it differs from the transceiver circuit in the foregoing EMBODIMENT 2 (FIG. 3) with respect to the fact that no permitted transfer rate comparison circuit is provided but TPBIAS mask circuit(s) 512 is/are provided within PORT state machine(s) 502; and with respect to the fact that operation is respectively different at PORT state machine(s) 502 and receive signal detection timer(s) 510. As the other components—i.e., PHY state machine(s) 501, transmitter(s) 503, receiver(s) 504, error detection circuit(s) 505, error counter(s) 506, error counter reset timer(s) 507, receive signal detection circuit(s) 509, cable connect detection circuit(s) 511, and so forth—have functions respectively identical to those of the respective circuits described at EMBODIMENT 2, detailed description thereof will be omitted.

In the present embodiment, in the event that it is determined that channel quality is sufficient to allow normal data transfer to be carried out, masking within TPBIAS mask circuit 512 is disabled and PORT state machine 502 is allowed to be notified by the TPBIAS signal indicating data transfer request(s) from PHY state machine 501.

PORT state machine 502, being an OP i.LINK-compliant PORT state machine, carries out transmission and reception of tone signals, establishing connection(s) with opposing port(s), carrying out speed negotiation, transitioning to data transfer phase upon normal termination of speed negotiation, and carrying out 8B/10B modulation of IEEE 1394-compliant arbitration signals and packets from PHY state machine 501 and sending same over cable(s) by way of transmitter 503.

Furthermore, PORT state machine 502 carries out 8B/10B demodulation of receive signals received from receiver 504, and thereafter carries out error detection by means of error detection circuit 505, receive signals for which no error has been detected being output to PHY state machine 501 as IEEE 1394-compliant arbitration signals or packets. In addition, in the event that, the error rate of the channel being greater than a preestablished error rate, error detection circuit 505, error counter 506, and error counter reset timer 507 determine during data transfer phase that channel quality is poor, transition is made from data transfer phase to tone phase, and masking by TPBIAS mask circuit 512 is thereafter enabled, masking the TPBIAS from PHY state machine 501.

By so doing, because the PORT will always see an inactive TPBIAS from the PHY when it has been determined that channel quality is poor and transition has been made from data transfer phase to tone phase, it will be impossible to transmit long tone(s) and/or continuous signal(s), making it possible to achieve operation such that transition cannot be made to speed negotiation phase.

Furthermore, receive signal detection circuit 509 and timer 510 make it possible to recognize that remote PORT(s) have been completely disconnected therefrom when remote signal(s) have not been detected for a preestablished fixed time or longer.

Under OP i.LINK, in the event that the internal INVALID_COUNT reaches a preestablished value and transition is made to data transfer phase, if, based on the parent-child relationship previously established in tone phase, the local node is a parent node then it will initiate transmission of short tones after a delay of 64 ms, this being one-half of the tone cycle; but if the node is a child node, then it will transmit short tones immediately upon making the transition to tone phase. That is, except where transition has been made to tone phase as a result of errors resulting from the fact that the channel has been completely disconnected due to insertion/removal of cable(s), even where transition has been made to tone phase due to errors transmission of tone signals from the local port should be followed, after a time of from 64 ms (one-half of the tone cycle) to 132 ms (one tone cycle), by receipt of tone signals sent from the remote PORT.

An appropriate value in the foregoing range of 64 ms to 132 ms is therefore chosen, the local port transmits tone signal(s), timer 510 being reset simultaneously therewith, and in the event that the value of timer 510 reaches the chosen value (fixed time) in the foregoing range 64 ms to 132 ms with receive signal still not having been detected by receive signal detection circuit 509, this may be interpreted as meaning that the remote PORT has been completely disconnected as a result of removal of the cable or for some other similar reason. Furthermore, cable connect detection circuit 511 is capable of detecting whether the cable is unplugged at the local port, and in the event that cable connect detection circuit 511 detects that the cable is unplugged, this may be interpreted as meaning that remote PORT(s) have been completely disconnected therefrom.

In accordance with the foregoing method, in the event that it is established that remote PORT(s) have been completely disconnected therefrom, since there is a possibility that cable(s) might have been replaced, repairs might have been made to transceiver(s), and/or the like, PORT state machine 502, error detection circuit 505, and TPBIAS mask circuit 512 may be reset, and, by disabling masking within TPBIAS mask circuit 512, it is possible to achieve operation such that, if data transfer request(s) is/are again generated within PHY state machine 501 and TPBIAS goes active, PORT state machine 502 will be notified of such fact and long tone(s) and/or continuous signal(s) will be transmitted over cable(s), permitting transition to speed negotiation phase(s).

Furthermore, where it has been recognized that remote PORT(s) have been completely disconnected therefrom, receive signal detection circuit 509 and/or cable connect detection circuit 511 make it possible to reinitiate transmission over cable(s) of long tone signal(s) and/or continuous signal(s) that had been suppressed, permitting reinitiation of communication.

Furthermore, by using an LED, for example, or other such external display apparatus 514 to notify the user of the fact that, channel quality-being poor, transition to data transfer ready state is being suppressed, it is possible to expect that channel quality might be improved as a result of replacement of cable(s), repairs to transceiver(s), and so forth.

Embodiment 6

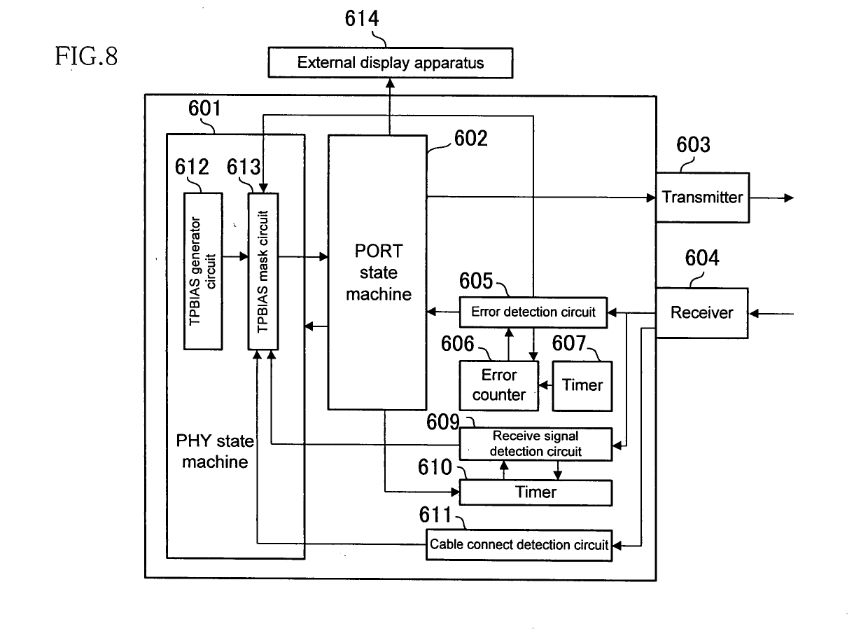

FIG. 8 is a block diagram showing circuit structure in a sixth embodiment of the present invention.

Characteristic of the present embodiment is that it differs from the transceiver circuit in the foregoing EMBODIMENT 2 (FIG. 3) with respect to the fact that no permitted transfer rate comparison circuit is provided but TPBIAS generator circuit(s) 612 and TPBIAS mask circuit(s) 613 are provided within PHY state machine(s) 601; and with respect to the fact that operation is respectively different at PORT state machine(s) 602 and receive signal detection timer(s) 610. As the other components—i.e., transmitter(s) 603, receiver(s) 604, error detection circuit(s) 605, error counter(s) 606, error counter reset timer(s) 607, receive signal detection circuit(s) 609, cable connect detection circuit(s) 611, and so forth—have functions respectively identical to those of the respective circuits described at EMBODIMENT 2, detailed description thereof will be omitted.

In the present embodiment, in the event that it is determined that channel quality is sufficient to allow normal data transfer to be carried out, masking within TPBIAS mask circuit 613 is disabled and PORT state machine 602 is allowed to be notified by the TPBIAS signal generated by TPBIAS generator circuit 612 within PHY state machine 601.

PORT state machine 602, being an OP i.LINK-compliant PORT state machine, carries out transmission and reception of tone signals, establishing connection(s) with opposing port(s), carrying out speed negotiation, transitioning to data transfer phase upon normal termination of speed negotiation, and carrying out 8B/10B modulation of IEEE 1394-compliant arbitration signals and packets from PHY state machine 601 and sending same over cable(s) by way of transmitter 603. Furthermore, PORT state machine 602 carries out 8B/10B demodulation of receive signals received from receiver 604, and thereafter carries out error detection by means of error detection circuit 605, receive signals for which no error has been detected being output to PHY state machine 601 as IEEE 1394-compliant arbitration signals or packets. In addition, in the event that, the error rate of the channel being greater than a preestablished error rate, error detection circuit 605, error counter 606, and error counter reset timer 607 determine during data transfer phase that channel quality is poor, transition is made from data transfer phase to tone phase, and masking by TPBIAS mask circuit 613 is thereafter enabled, masking the TPBIAS signal generated by TPBIAS generator circuit 612.

By so doing, because the PORT will always see an inactive TPBIAS from the PHY when it has been determined that channel quality is poor and transition has been made from data transfer phase to tone phase, it will be impossible to transmit long tone(s) and/or continuous signal(s), making it possible to achieve operation such that transition cannot be made to speed negotiation phase.

Furthermore, receive signal detection circuit 609 and timer 610 make it possible to recognize that remote PORT(s) have been completely disconnected therefrom when remote signal(s) have not been detected for a preestablished fixed time or longer.

Under OP i.LINK, in the event that the internal INVALID_COUNT reaches a preestablished value and transition is made to data transfer phase, if, based on the parent-child relationship previously established in tone phase, the local node is a parent node then it will initiate transmission of short tones after a delay of 64 ms, this being one-half of the tone cycle; but if the node is a child node, then it will transmit short tones immediately upon making the transition to tone phase. That is, except where transition has been made to tone phase as a result of errors resulting from the fact that the channel has been completely disconnected due to insertion/removal of cable(s), even where transition has been made to tone phase due to errors transmission of tone signals from the local port should be followed, after a time of from 64 ms (one-half of the tone cycle) to 132 ms (one tone cycle), by receipt of tone signals sent from the remote PORT.

An appropriate value in the foregoing range of 64 ms to 132 ms is therefore chosen, the local port transmits tone signal(s), timer 610 being reset simultaneously therewith, and in the event that the value of timer 610 reaches the chosen value in the range 64 ms to 132 ms with receive signal still not having been detected by receive signal detection circuit 609, this may be interpreted as meaning that the remote PORT has been completely disconnected as a result of removal of the cable or for some other similar reason. Furthermore, cable connect detection circuit 611 is capable of detecting whether the cable is unplugged at the local port, and in the event that cable connect detection circuit 611 detects that the cable is unplugged, this may be interpreted as meaning that remote PORT(s) have been completely disconnected therefrom.

In accordance with the foregoing method, in the event that it is established that remote PORT(s) have been completely disconnected therefrom, since there is a possibility that cable(s) might have been replaced, repairs might have been made to transceiver(s), and/or the like, PORT state machine 602, error detection circuit 605, and TPBIAS mask circuit 613 may be reset, and, by disabling masking within TPBIAS mask circuit 613, it is possible to achieve operation such that, if data transfer request(s) is/are again generated within PHY state machine 601 and TPBIAS goes active, PORT state machine 602 will be notified of such fact and long tone(s) and/or continuous signal(s) will be transmitted over cable(s), permitting transition to speed negotiation phase(s).

Furthermore, where it has been recognized that remote PORT(s) have been completely disconnected therefrom, receive signal detection circuit 609 and/or cable connect detection circuit 611 make it possible to reinitiate transmission over cable(s) of long tone signal(s) and/or continuous signal(s) that had been suppressed, permitting reinitiation of communication.

Furthermore, by using an LED, for example, or other such external display apparatus 614 to notify the user of the fact that, channel quality being poor, transition to data transfer ready state is being suppressed, it is possible to expect that channel quality might be improved as a result of replacement of cable(s), repairs to transceiver(s), and so forth.

Embodiment 7

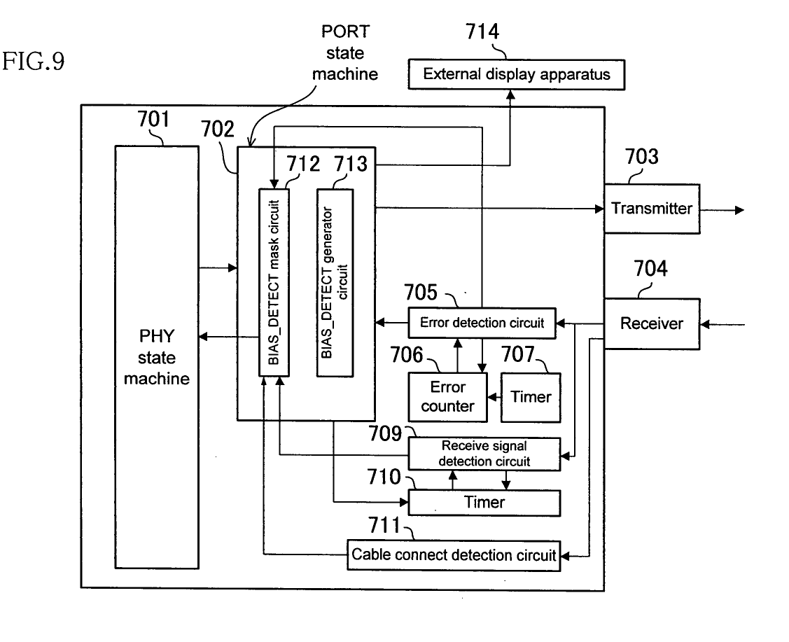

FIG. 9 is a block diagram showing circuit structure in a seventh embodiment of the present invention.

Characteristic of the present embodiment is that it differs from the transceiver circuit in the foregoing EMBODIMENT 2 (FIG. 3) with respect to the fact that no permitted transfer rate comparison circuit is provided but BIAS_DETECT mask circuit(s) 712 and BIAS_DETECT generator circuit(s) 713 are provided within PORT state machine(s) 702; and with respect to the fact that operation is respectively different at PORT state machine(s) 702 and receive signal detection timer(s) 710. As the other components—i.e., PHY state machine(s) 701, transmitter(s) 703, receiver(s) 704, error detection circuit(s) 705, error counter(s) 706, error counter reset timer(s) 707, receive signal detection circuit(s) 709, cable connect detection circuit(s) 711, and so forth—have functions respectively identical to those of the respective circuits described at EMBODIMENT 2, detailed description thereof will be omitted.

In the present embodiment, in the event that it is determined that channel quality is sufficient to allow normal data transfer to be carried out, masking within BIAS_DETECT mask circuit 712 is disabled and PHY state machine 701 is allowed to be notified by the BIAS_DETECT signal generated by BIAS_DETECT generator circuit 713 within PORT state machine 702.

PORT state machine 702, being an OP i.LINK-compliant PORT state machine, carries out transmission and reception of tone signals, establishing connection(s) with opposing port(s), carrying out speed negotiation, transitioning to data transfer phase upon normal termination of speed negotiation, and carrying out 8B/10B modulation of IEEE 1394-compliant arbitration signals and packets from PHY state machine 701 and sending same over cable(s) by way of transmitter 703. Furthermore, PORT state machine 702 carries out 8B/10B demodulation of receive signals received from receiver 704, and thereafter carries out error detection by means of error detection circuit 705, receive signals for which no error has been detected being output to PHY state machine 701 as IEEE 1394-compliant arbitration signals or packets. In addition, in the event that, the error rate of the channel being greater than a preestablished error rate, error detection circuit 705, error counter 706, and error counter reset timer 707 determine during data transfer phase that channel quality is poor, transition is made from data transfer phase to tone phase, and masking by BIAS_DETECT mask circuit 712 is thereafter enabled, masking the BIAS_DETECT signal controlled by BIAS_DETECT generator circuit 713.

By so doing, because the PHY will always see an inactive BIAS_DETECT signal from the PORT when it has been determined that channel quality is poor and transition has been made from data transfer phase to tone phase, it will be impossible to recognize data transfer request(s) from remote device(s), making it possible to achieve operation such that transition cannot be made to speed negotiation phase.

Furthermore, receive signal detection circuit 709 and timer 710 make it possible to recognize that remote PORT(s) have been completely disconnected therefrom when remote signal(s) have not been detected for a preestablished fixed time or longer.

Under OP i.LINK, in the event that the internal INVALID_COUNT reaches a preestablished value and transition is made to data transfer phase, if, based on the parent-child relationship previously established in tone phase, the local node is a parent node then it will initiate transmission of short tones after a delay of 64 ms, this being one-half of the tone cycle; but if the node is a child node, then it will transmit short tones immediately upon making the transition to tone phase. That is, except where transition has been made to tone phase as a result of errors resulting from the fact that the channel has been completely disconnected due to insertion/removal of cable(s), even where transition has been made to tone phase due to errors transmission of tone signals from the local port should be followed, after a time of from 64 ms (one-half of the tone cycle) to 132 ms (one tone cycle), by receipt of tone signals sent from the remote PORT.

An appropriate value in the foregoing range of 64 ms to 132 ms is therefore chosen, the local port transmits tone signal(s), timer 710 being reset simultaneously therewith, and in the event that the value of timer 710 reaches the chosen value (fixed time) in the range 64 ms to 132 ms with receive signal still not having been detected by receive signal detection circuit 709, this may be interpreted as meaning that the remote PORT has been completely disconnected as a result of removal of the cable or for some other similar reason. Furthermore, cable connect detection circuit 711 is capable of detecting whether the cable is unplugged at the local port, and in the event that cable connect detection circuit 711 detects that the cable is unplugged, this may be interpreted as meaning that remote PORT(s) have been completely disconnected therefrom.

In accordance with the foregoing method, in the event that it is established that remote PORT(s) have been completely disconnected therefrom, since there is a possibility that cable(s) might have been replaced, repairs might have been made to transceiver(s), and/or the like, PORT state machine 702, error detection circuit 705, and BIAS_DETECT mask circuit 712 may be reset, and, by disabling masking within BIAS_DETECT mask circuit 712, it is possible to achieve operation such that, if long tone(s) and/or continuous signal(s) transmitted by remote device(s) is/are received within PORT state machine 702 and BIAS_DETECT again goes active, PHY state machine 701 will be notified of such fact, permitting transition to speed negotiation phase(s).

Furthermore, where it has been recognized that remote PORT(s) have been completely disconnected therefrom, receive signal detection circuit 709 and/or cable connect detection circuit 711 make it possible to reinitiate BIAS_DETECT notification that had been suppressed, permitting reinitiation of communication.

Furthermore, by using an LED, for example, or other such external display apparatus 714 to notify the user of the fact that, channel quality being poor, transition to data transfer ready state is being suppressed, it is possible to expect that channel quality might be improved as a result of replacement of cable(s), repairs to transceiver(s), and so forth.

Embodiment 8

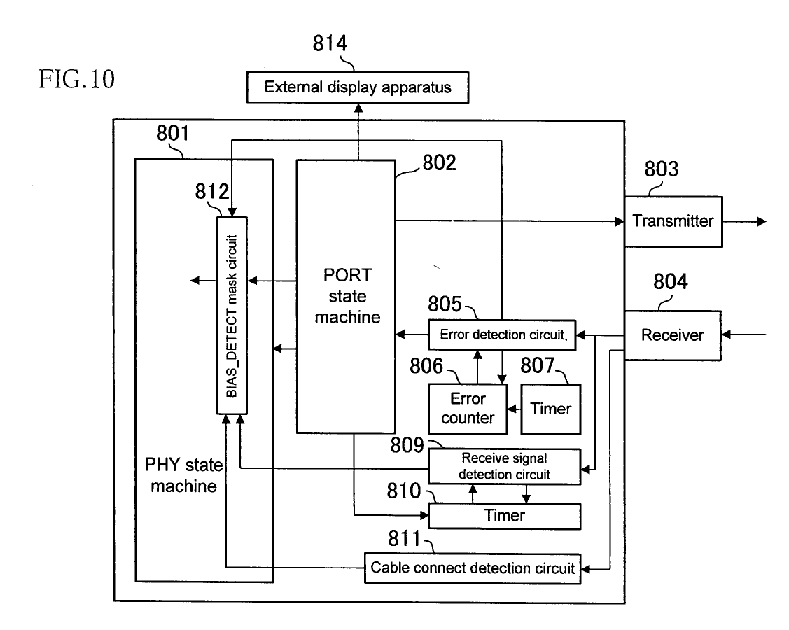

FIG. 10 is a block diagram showing circuit structure in an eighth embodiment of the present invention.

Characteristic of the present embodiment is that it differs from the transceiver circuit in the foregoing EMBODIMENT 2 (FIG. 3) with respect to the fact that no permitted transfer rate comparison circuit is provided but BIAS_DETECT mask circuit(s) 812 is/are provided within PHY state machine(s) 801; and with respect to the fact that operation is respectively different at PORT state machine(s) 802 and receive signal detection timer(s) 810. As the other components—i.e., transmitter(s) 803, receiver(s) 804, error detection circuit(s) 805, error counter(s) 806, error counter reset timer(s) 807, receive signal detection circuit(s) 809, cable connect detection circuit(s) 811, and so forth—have functions respectively identical to those of the respective circuits described at EMBODIMENT 2, detailed description thereof will be omitted.

In the present embodiment, in the event that it is determined that channel quality is sufficient to allow normal data transfer to be carried out, masking within BIAS_DETECT mask circuit 812 is disabled and PHY state machine 801 is allowed to be notified by the BIAS_DETECT signal generated by PORT state machine 802.

PORT state machine 802, being an OP i.LINK-compliant PORT state machine, carries out transmission and reception of tone signals, establishing connection(s) with opposing port(s), carrying out speed negotiation, transitioning to data transfer phase upon normal termination of speed negotiation, and carrying out 8B/10B modulation of IEEE 1394-compliant arbitration signals and packets from PHY state machine 801 and sending same over cable(s) by way of transmitter 803. Furthermore, PORT state machine 802 carries out 8B/10B demodulation of receive signals received from receiver 804, and thereafter carries out error detection by means of error detection circuit 805, receive signals for which no error has been detected being output to PHY state machine 801 as IEEE 1394-compliant arbitration signals or packets. In addition, in the event that, the error rate of the channel being greater than a preestablished error rate, error detection circuit 805, error counter 806, and error counter reset timer 807 determine during data transfer phase that channel quality is poor, transition is made from data transfer phase to tone phase, and masking by BIAS_DETECT mask circuit 812 is thereafter enabled, masking the BIAS_DETECT signal generated by PORT state machine 802.

By so doing, because PHY state machine 801 will always determine that the BIAS_DETECT signal from PORT state machine 802 is inactive when it has been determined that channel quality is poor and transition has been made from data transfer phase to tone phase, it will be impossible to recognize data transfer request(s) from remote device(s), making it possible to achieve operation such that transition cannot be made to speed negotiation phase.

Furthermore, receive signal detection circuit 809 and timer 810 make it possible to recognize that remote PORT(s) have been completely disconnected therefrom when remote signal(s) have not been detected for a preestablished fixed time or longer.

Under OP i.LINK, in the event that the internal INVALID_COUNT reaches a preestablished value and transition is made to data transfer phase, if, based on the parent-child relationship previously established in tone phase, the local node is a parent node then it will initiate transmission of short tones after a delay of 64 ms, this being one-half of the tone cycle; but if the node is a child node, then it will transmit short tones immediately upon making the transition to tone phase. That is, except where transition has been made to tone phase as a result of errors resulting from the fact that the channel has been completely disconnected due to insertion/removal of cable(s), even where transition has been made to tone phase due to errors transmission of tone signals from the local port should be followed, after a time of from 64 ms (one-half of the tone cycle) to 132 ms (one tone cycle), by receipt of tone signals sent from the remote PORT.

An appropriate value in the foregoing range of 64 ms to 132 ms is therefore chosen, the local port transmits tone signal(s), timer 810 being reset simultaneously therewith, and in the event that the value of timer 810 reaches the chosen value in the range 64 ms to 132 ms with receive signal still not having been detected by receive signal detection circuit 809, this may be interpreted as meaning that the remote PORT has been completely disconnected as a result of removal of the cable or for some other similar reason. Furthermore, cable connect detection circuit 811 is capable of detecting whether the cable is unplugged at the local port, and in the event that cable connect detection circuit 811 detects that the cable is unplugged, this may be interpreted as meaning that remote PORT(s) have been completely disconnected therefrom.

In accordance with the foregoing method, in the event that it is established that remote PORT(s) have been completely disconnected therefrom, since there is a possibility that cable(s) might have been replaced, repairs might have been made to transceiver(s), and/or the like, PORT state machine 802, error detection circuit 805, and BIAS_DETECT mask circuit 812 may be reset, and, by disabling masking within BIAS_DETECT mask circuit 812, it is possible to achieve operation such that, if long tone(s) and/or continuous signal(s) transmitted by remote device(s) is/are received within PORT state machine 802 and BIAS_DETECT again goes active, PHY state machine 801 will be notified of such fact, permitting transition to speed negotiation phase(s).

Furthermore, where it has been recognized that remote PORT(S) have been completely disconnected therefrom, receive signal detection circuit 809 and/or cable connect detection circuit 811 make it possible to reinitiate BIAS_DETECT notification that had been suppressed, permitting reinitiation of communication.

Furthermore, by using an LED, for example, or other such external display apparatus 814 to notify the user of the fact that, channel quality being poor, transition to data transfer ready state is being suppressed, it is possible to expect that channel quality might be improved as a result of replacement of cable(s), repairs to transceiver(s), and so forth.

Embodiment 9

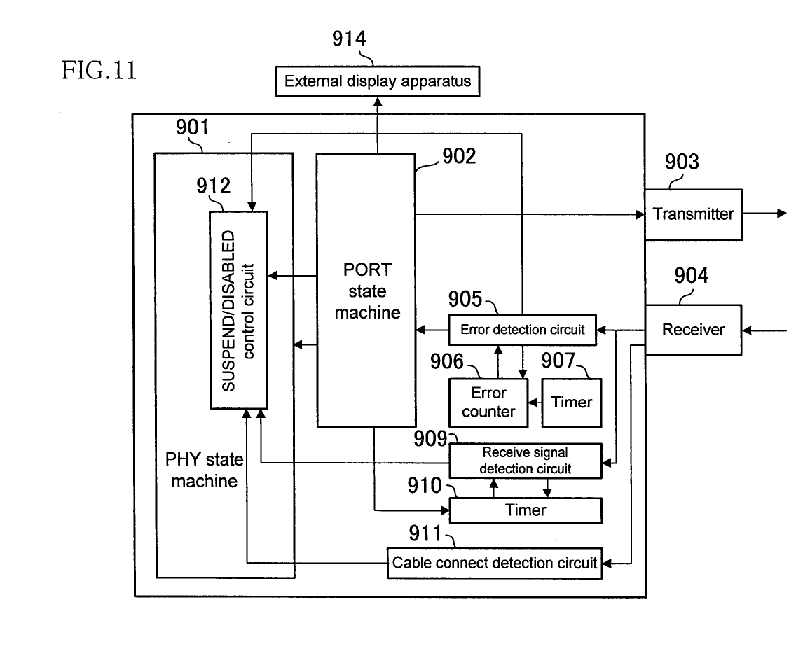

FIG. 11 is a block diagram showing circuit structure in a ninth embodiment of the present invention.

Characteristic of the present embodiment is that it differs from the transceiver circuit in the foregoing EMBODIMENT 2 (FIG. 3) with respect to the fact that no permitted transfer rate comparison circuit is provided but SUSPEND/DISABLED control circuit(s) 912 is/are provided within PHY state machine(s) 901; and with respect to the fact that operation is respectively different at PORT state machine(s) 902 and receive signal detection timer(s) 910. As the other components—i.e., transmitter(s) 903, receiver(s) 904, error detection circuit(s) 905, error counter(s) 906, error counter reset timer(s) 907, receive signal detection circuit(s) 909, cable connect detection circuit(s) 911, and so forth—have functions respectively identical to those of the respective circuits described at EMBODIMENT 2, detailed description thereof will be omitted.

In the present embodiment, in the event that it is determined that channel quality is sufficient to allow normal data transfer to be carried out, the SUSPEND signal and the DISABLED signal controlled by SUSPEND/DISABLED control circuit 912 are both set so as to be inactive.

PORT state machine 902, being an OP i.LINK-compliant PORT state machine, carries out transmission and reception of tone signals, establishing connection(s) with opposing port(s), carrying out speed negotiation, transitioning to data transfer phase upon normal termination of speed negotiation, and carrying out 8B/10B modulation of IEEE 1394-compliant arbitration signals and packets from PHY state machine 901 and sending same over cable(s) by way of transmitter 903. Furthermore, PORT state machine 902 carries out 8B/10B demodulation of receive signals received from receiver 904, and thereafter carries out error detection by means of error detection circuit 905, receive signals for which no error has been detected being output to PHY state machine 901 as IEEE 1394-compliant arbitration signals or packets. Furthermore, in the event that, the error rate of the channel being greater than a preestablished error rate, error detection circuit 905, error counter 906, and error counter reset timer 907 determine during data transfer phase that channel quality is poor, transition is made from data transfer phase to tone phase, and SUSPEND/DISABLED control circuit 912 is thereafter notified to the effect that it should cause the PORT state to undergo transition to SUSPEND or DISABLED state. In response thereto, SUSPEND/DISABLED control circuit 912 sets SUSPEND active, causing the PORT to undergo transition to a suspended state; or sets DISABLED active, causing the PORT to undergo transition to a disabled state. When the PORT is in a suspended state, no transition is made to speed negotiation phase so long as PHY state machine 901 does not set TPBIAS active. Furthermore, when the PORT is in a disabled state, no transition is made to speed negotiation phase so long as DISABLED is not returned to its inactive condition.

By so doing, if, when it has been determined that channel quality is poor and transition has been made from data transfer phase to tone phase, SUSPEND/DISABLED control circuit 912 within PHY state machine 901 is notified of such fact and the PORT is made to undergo transition to suspended state or disabled state, it will be possible to achieve operation such that transition cannot be made to speed negotiation phase.

Furthermore, receive signal detection circuit 909 and timer 910 make it possible to recognize that remote PORT(s) have been completely disconnected therefrom when remote signal(s) have not been detected for a preestablished fixed time or longer.

Under OP i.LINK, in the event that the internal INVALID_COUNT reaches a preestablished value and transition is made to data transfer phase, if, based on the parent-child relationship previously established in tone phase, the local node is a parent node then it will initiate transmission of short tones after a delay of 64 ms, this being one-half of the tone cycle; but if the node is a child node, then it will transmit short tones immediately upon making the transition to tone phase. That is, except where transition has been made to tone phase as a result of errors resulting from the fact that the channel has been completely disconnected due to insertion/removal of cable(s), even where transition has been made to tone phase due to errors transmission of tone signals from the local port should be followed, after a time of from 64 ms (one-half of the tone cycle) to 132 ms (one tone cycle), by receipt of tone signals sent from the remote PORT.

An appropriate value in the foregoing range of 64 ms to 132 ms is therefore chosen, the local port transmits tone signal(s), timer 910 being reset simultaneously therewith, and in the event that the value of timer 910 reaches the chosen value in the range 64 ms to 132 ms with receive signal still not having been detected by receive signal detection circuit 909, this may be interpreted as meaning that the remote PORT has been completely disconnected as a result of removal of the cable or for some other similar reason. Furthermore, cable connect detection circuit 911 is capable of detecting whether the cable is unplugged at the local port, and in the event that cable connect detection circuit 911 detects that the cable is unplugged, this may be interpreted as meaning that remote PORT(s) have been completely disconnected therefrom.

In accordance with the foregoing method, in the event that it is established that remote PORT(s) have been completely disconnected therefrom, since there is a possibility that cable(s) might have been replaced, repairs might have been made to transceiver(s), and/or the like, PORT state machine 902, error detection circuit 905, and SUSPEND/DISABLED control circuit 912 may be reset, and, by causing the SUSPEND or DISABLED signal to go inactive, it will again be possible to notify PORT state machine 902 that TPBIAS is active, making it possible for the PORT to undergo transition to speed negotiation phase(s).

Furthermore, where it has been recognized that remote PORT(s) have been completely disconnected therefrom, receive signal detection circuit 909 and/or cable connect detection circuit 911 make it possible to terminate suspended and/or disabled state(s), permitting reinitiation of communication.

Furthermore, by using an LED, for example, or other such external display apparatus 914 to notify the user of the fact that, channel quality being poor, transition to data transfer ready state is being suppressed, it is possible to expect that channel quality might be improved as a result of replacement of cable(s), repairs to transceiver(s), and so forth.

Embodiment 10

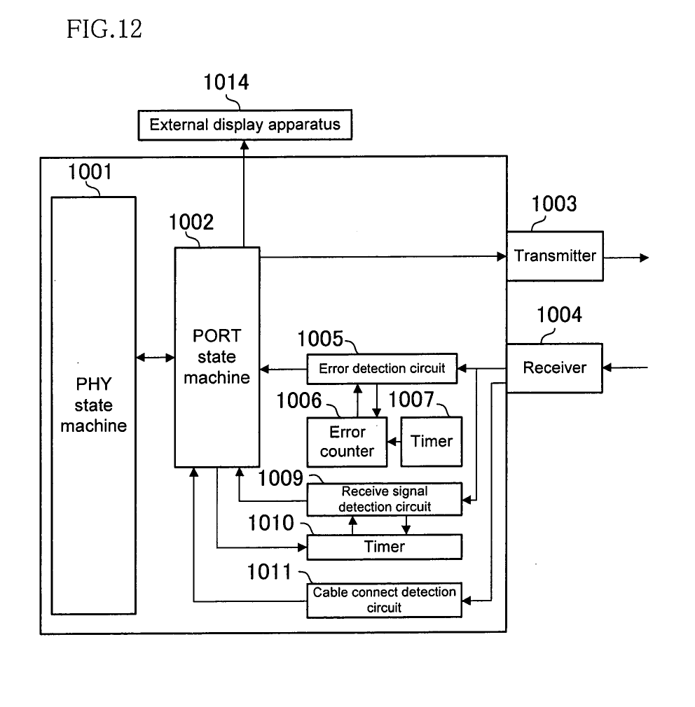

FIG. 12 is a block diagram showing circuit structure in a tenth embodiment of the present invention.

Characteristic of the present embodiment is that it differs from the transceiver circuit in the foregoing EMBODIMENT 2 (FIG. 3) with respect to the fact that operation is respectively different at PORT state machine(s) 1002 and receive signal detection timer(s) 1010. As the other components—i.e., PHY state machine(s) 1001, transmitter(s) 1003, receiver(s) 1004, error detection circuit(s) 1005, error counter(s) 1006, error counter reset timer(s) 1007, receive signal detection circuit(s) 1009, cable connect detection circuit(s) 1011, and so forth—have functions respectively identical to those of the respective circuits described at EMBODIMENT 2, detailed description thereof will be omitted.

PORT state machine 1002, being an OP i.LINK-compliant PORT state machine, carries out transmission and reception of tone signals, establishing connection(s) with opposing port(s), carrying out speed negotiation, transitioning to data transfer phase upon normal termination of speed negotiation, and carrying out 8B/10B modulation of IEEE 1394-compliant arbitration signals and packets from PHY state machine 1001 and sending same over cable(s) by way of transmitter 1003. Furthermore, PORT state machine 1002 carries out 8B/10B demodulation of receive signals received from receiver 1004, and thereafter carries out error detection by means of error detection circuit 1005, receive signals for which no error has been detected being output to PHY state machine 1001 as IEEE 1394-compliant arbitration signals or packets. In addition, in the event that, the error rate of the channel being greater than a preestablished error rate, error detection circuit 1005, error counter 1006, and error counter reset timer 1007 determine during data transfer phase that channel quality is poor, PORT state machine 1002 undergoes transition from data transfer phase to phase(s) where improvement in channel quality is awaited. While in the foregoing phase(s) in which channel quality is to be improved, PORT state machine 1002 carries out repeated transmission and reception of tone signals until such time as it is established that remote PORT(s) have been completely disconnected therefrom.

By so doing, if it is determined that channel quality is poor, transition is not made from data transfer phase directly to tone phase but to phase(s) where improvement in channel quality is awaited, making it possible to achieve operation such that transition cannot automatically be again made to speed negotiation phase.

Furthermore, receive signal detection circuit 1009 and timer 1010 make it possible to recognize that remote PORT(s) have been completely disconnected therefrom when remote signal(s) have not been detected for a preestablished fixed time or longer. Under OP i.LINK, in the event that the internal INVALID_COUNT reaches a preestablished value and transition is made to data transfer phase, if, based on the parent-child relationship previously established in tone phase, the local node is a parent node then it will initiate transmission of short tones after a delay of 64 ms, this being one-half of the tone cycle; but if the node is a child node, then it will transmit short tones immediately upon making the transition to tone phase. That is, except where transition has been made to tone phase as a result of errors resulting from the fact that the channel has been completely disconnected due to insertion/removal of cable(s), even where transition has been made to tone phase due to errors transmission of tone signals from the local port should be followed, after a time of from 64 ms (one-half of the tone cycle) to 132 ms (one tone cycle), by receipt of tone signals sent from the remote PORT.

An appropriate value in the foregoing range of 64 ms to 132 ms is therefore chosen, the local port transmits tone signal(s), timer 1010 being reset simultaneously therewith, and in the event that the value of timer 1010 reaches the chosen value in the range 64 ms to 132 ms with receive signal still not having been detected by receive signal detection circuit 1009, this may be interpreted as meaning that the remote PORT has been completely disconnected as a result of removal of the cable or for some other similar reason. Furthermore, cable connect detection circuit 1011 is capable of detecting whether the cable is unplugged at the local port, and in the event that cable connect detection circuit 1011 detects that the cable is unplugged, this may be interpreted as meaning that remote PORT(s) have been completely disconnected therefrom.

In accordance with the foregoing method, in the event that it is established that remote PORT(s) have been completely disconnected therefrom, since there is a possibility that cable(s) might have been replaced, repairs might have been made to transceiver(s), and/or the like, PORT state machine 1002 may be made to undergo transition to tone phase from phase(s) where improvement in channel quality was awaited and error counter 1006 may be reset.

In accordance with the foregoing method, where it has been recognized that remote PORT(s) have been completely disconnected therefrom, receive signal detection circuit 1009 and/or cable connect detection circuit 1011 make it possible for transition to be made to tone phase from phase(s) where improvement in channel quality was awaited, permitting reinitiation of communication.

Furthermore, by using an LED, for example, or other such external display apparatus 1014 to notify the user of the fact that, channel quality being poor, transition to data transfer ready state is being suppressed, it is possible to expect that channel quality might be improved as a result of replacement of cable(s), repairs to transceiver(s), and so forth.

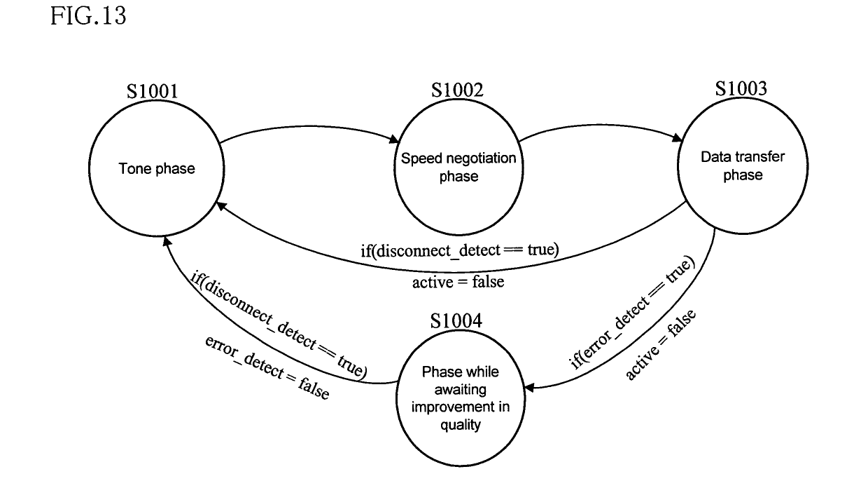

Next, referring to FIG. 13, state transitions of PORT state machine 1002 of the present embodiment are described. Note moreover that since operation in the respective states at tone phase S1001, speed negotiation phase S1002, and data transfer phase S1003 are as described at OP i.LINK, Ver. 1.0, p. 60, detailed description thereof will be omitted.

In the event that, the error rate of the channel being greater than a preestablished error rate, error detection circuit 1005, error counter 1006, and error counter reset timer 1007 determine during data transfer phase that channel quality is poor, transition is made from data transfer phase S1003 to phase S1004 where improvement in channel quality is awaited. In the foregoing phase where improvement in channel quality is awaited, transmission and reception of tone signals is carried out while complete disconnection of remote PORT(s) therefrom is awaited.

If receive signal detection circuit 1009 and/or cable connect detection circuit 1011 in FIG. 12 and/or the like establish that the remote PORT has been completely disconnected therefrom and DISCONNECT_DETECT goes TRUE, then since there is a possibility that channel quality might have improved, the error detection signal ERROR_DETECT may be set to FALSE and transition may be made to tone phase S1001 in initialized state.

By imparting PORT state machine 1002 with phase(s) in which improvement in channel quality is newly awaited as described above, it is possible to achieve operation such that, even where channel quality is poor, transition is made from data transfer phase to tone phase, and automatic transition back to speed negotiation is thereafter suppressed.

Embodiment 11

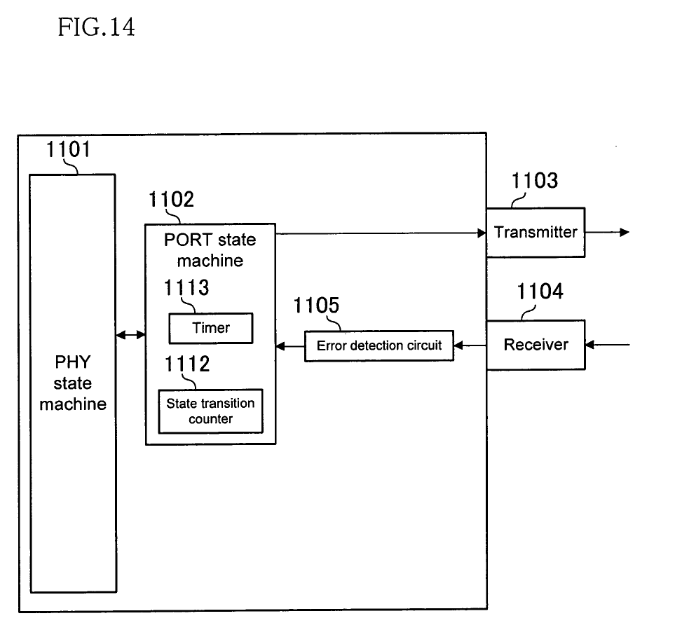

FIG. 14 is a block diagram showing circuit structure in an eleventh embodiment of the present invention.

Characteristic of the present embodiment is that it differs from the transceiver circuit in the foregoing EMBODIMENT 1 (FIG. 1) with respect to the fact that the error counter(s) is/are eliminated, and state transition counter(s) 1112 and timer(s) 1113 are provided within PORT state machine(s) 1102; and with respect to the fact that operation is different at PORT state machine(s) 1102. As the other components—i.e., PHY state machine(s) 1101, transmitter(s) 1103, receiver(s) 1104, and so forth—have functions respectively identical to those of the respective circuits described at EMBODIMENT 1, detailed description thereof will be omitted.

State transition counter 1112 within PORT state machine 1102 is a counter that is incremented by 1 every time the state of the PORT undergoes transition from tone phase to speed negotiation phase. Furthermore, timer 1113 within PORT state machine 1102, which might be reset when, for example, cable(s) is/are connected, measures the time until state transition counter 1112 reaches a preestablished value.

PORT state machine 1102, being an OP i.LINK-compliant PORT state machine, carries out transmission and reception of tone signals, establishing connection(s) with opposing port(s), carrying out speed negotiation, transitioning to data transfer phase upon normal termination of speed negotiation, and carrying out 8B/10B modulation of IEEE 1394-compliant arbitration signals and packets from PHY state machine 1101 and sending same over cable(s) by way of transmitter 1103. Furthermore, PORT state machine 1102 carries out 8B/10B demodulation of receive signals received from receiver 1104, and thereafter carries out error detection by means of error detection circuit 1105, receive signals for which no error has been detected being output to PHY state machine 1101 as IEEE 1394-compliant arbitration signals or packets. Furthermore, in the event that the internal counter INVALID_COUNT reaches a preestablished value and it is determined during data transfer phase that channel quality is poor, and/or error(s) is/are detected at state B2 and/or state B3 during speed negotiation phase, transition is made to tone phase, and thereafter, if TPBIAS and BIAS_DETECT go active then transition is made to speed negotiation phase.

State transition counter 1112 is incremented by 1 at each instance of a transition from tone phase to speed negotiation phase as has just been described, and if the time it takes for state transition counter 1112 to reach a preestablished value is less than or equal to a preestablished time, then, it being determined that channel quality is extremely poor, transition from tone phase to speed negotiation phase is suppressed. The transceiver circuit by means of which such suppression of transition is implemented may be a transceiver circuit as described at any of the foregoing EMBODIMENT 1 through EMBODIMENT 10.

The present invention may be embodied in a wide variety of forms other than those presented herein without departing from the spirit or essential characteristics thereof. The foregoing embodiments and working examples, therefore, are in all respects merely illustrative and are not to be construed in limiting fashion. The scope of the present invention being as indicated by the claims, it is not to be constrained in any way whatsoever by the body of the specification. All modifications and changes within the range of equivalents of the claims are moreover within the scope of the present invention.

1. A transceiver circuit capable of transferring data at one or more transfer rates, the transceiver circuit comprising:
one or more state machines having one or more tone phases in which determination of the maximum transfer rate for one or more channels and one or more connections with one or more remote devices is carried out through exchange of one or more tone signals with at least one of the remote device or devices, and one or more data transfer phases in which data transfer is carried out at one or more frequencies higher than that of at least one of the tone signal or signals;
one or more error detection circuits detecting one or more errors in one or more receive signals; and
one or more data transfer phase transition suppressor circuits;
wherein, in the event that at least one of the error detection circuit or circuits detects at least one of the error or errors within at least one of the receive signal or signals during at least one of the data transfer phase or phases, one or more transitions is made from at least one of the data transfer phase or phases to at least one of the tone phase or phases, and after at least one of such transition or transitions has occurred, at least one of the data transfer phase transition suppressor circuit or circuits carries out control so as to prevent transition back to at least one of the data transfer phase or phases.

2. A transceiver circuit according to claim 1 further comprising:
one or more timers; and
one or more error counters;
wherein, only in the event that one or more numbers of errors occurring within one or more fixed times as detected by at least one of the error detection circuit or circuits, at least one of the timer or timers, and at least one of the error counter or counters during at least one of the data transfer phase or phases is greater than at least one preestablished value, one or more transitions is made from at least one of the data transfer phase or phases to at least one of the tone phase or phases, and after at least one of such transition or transitions has occurred, at least one of the data transfer phase transition suppressor circuit or circuits carries out control so as to prevent transition back to at least one of the data transfer phase or phases.

3. A transceiver circuit according to claim 1 further comprising:
one or more transfer rate comparison circuits comparing the minimum transfer rate of which the transceiver circuit is capable and one or more transfer rates employed during at least one of the data transfer phase or phases;
wherein, only in the event that at least one of the error detection circuit or circuits detects at least one of the error or errors and at least one of the transition or transitions is made from at least one of the data transfer phase or phases to at least one of the tone phase or phases when at least one result of at least one comparison made by at least one of the transfer rate comparison circuit or circuits is that at least one of the transfer rate or rates employed during at least one of the data transfer phase or phases is identical to the minimum transfer rate or rates of which the transceiver circuit is capable, at least one of the data transfer phase transition suppressor circuit or circuits carries out control so as to prevent transition back to at least one of the data transfer phase or phases.

4. A transceiver circuit capable of transferring data at one or more transfer rates, the transceiver circuit comprising:
one or more state machines having one or more tone phases in which one or more connections with one or more remote devices are established through exchange of one or more tone signals with at least one of the remote device or devices, one or more speed negotiation phases in which determination of the maximum transfer rate permitted by one or more channels is carried out through mutual notification of one or more transfer rates of which the local device is capable, this notification being actually carried out at at least one of such transfer rate or rates, and one or more data transfer phases in which data transfer is carried out at at least one of the transfer rate or rates determined at at least one of the speed negotiation phase or phases;
one or more error detection circuits detecting one or more errors in one or more receive signals; and
one or more speed negotiation phase transition suppressor circuits;
wherein, in the event that at least one of the error detection circuit or circuits detects at least one of the error or errors within at least one of the receive signal or signals during at least one of the data transfer phase or phases, one or more transitions is made from at least one of the data transfer phase or phases to at least one of the tone phase or phases, and after at least one of such transition or transitions has occurred, at least one of the speed negotiation phase transition suppressor circuit or circuits carries out control so as to prevent transition to at least one of the speed negotiation phase or phases.

5. A transceiver circuit capable of transferring data at one or more transfer rates, the transceiver circuit comprising:
one or more state machines having one or more tone phases in which one or more connections with one or more remote devices are established through exchange of one or more tone signals with at least one of the remote device or devices, one or more speed negotiation phases in which determination of one or more maximum transfer rates permitted by one or more channels is carried out through mutual notification of one or more transfer rates of which the local device is capable, this notification being actually carried out at at least one of such transfer rate or rates, and one or more data transfer phases in which data transfer is carried out at at least one of the transfer rate or rates determined at at least one of the speed negotiation phase or phases;
one or more error detection circuits detecting one or more errors in one or more receive signals; and
one or more speed negotiation phase transition suppressor circuits;
wherein, in the event that at least one of the error detection circuit or circuits detects at least one of the error or errors within at least one of the receive signal or signals during at least one of the speed negotiation phase or phases, one or more transitions is made from at least one of the data transfer phase or phases to at least one of the tone phase or phases, and after at least one of such transition or transitions has occurred, at least one of the speed negotiation phase transition suppressor circuit or circuits carries out control so as to prevent transition to at least one of the speed negotiation phase or phases.

6. A transceiver circuit according to claim 4 further comprising:
one or more timers; and
one or more error counters;
wherein, only in the event that one or more numbers of errors occurring within one or more fixed times as detected by at least one of the error detection circuit or circuits, at least one of the timer or timers, and at least one of the error counter or counters is greater than at least one preestablished value, one or more transitions is made from at least one of the data transfer phase or phases to at least one of the tone phase or phases, and after at least one of such transition or transitions has occurred, at least one of the state machine phase transition suppressor circuit or circuits carries out control so as to prevent transition to at least one of the speed negotiation phase or phases.

7. A transceiver circuit according to claim 4 further comprising:
one or more transfer rate comparison circuits comparing minimum transfer rate of which the transceiver circuit is capable and one or more transfer rates employed during at least one of the data transfer phase or phases;
wherein, only in the event that at least one of the error detection circuit or circuits detects at least one of the error or errors and at least one of the transition or transitions is made from at least one of the data transfer phase or phases to at least one of the tone phase or phases when at least one result of at least one comparison made by at least one of the transfer rate comparison circuit or circuits is that at least one of the transfer rate or rates employed during at least one of the data transfer phase or phases is identical to at least one of the minimum transfer rate or rates of which the transceiver circuit is capable, at least one of the speed negotiation phase transition suppressor circuit or circuits carries out control so as to prevent transition to at least one of the speed negotiation phase or phases.

8. A transceiver circuit according to claim 4 further comprising:
one or more counters; and
one or more timers;
wherein the transceiver circuit is OP i.LINK-compliant;
wherein at least one of the counter or counters counts one or more numbers of transitions from at least one of the tone phase or phases to at least one of the speed negotiation phase or phases; and
wherein, in the event that at least one of the number or numbers of transitions as counted by at least one of the counter or counters reaches at least one preestablished value within at least one fixed time, it being determined that channel quality is poor, at least one of the speed negotiation phase transition suppressor circuit or circuits carries out control so as to prevent transition to at least one of the speed negotiation phase or phases.

9. A transceiver circuit according to claim 2 wherein:
one or more tone signal transmit select circuits are employed as at least one of the data transfer phase transition suppressor circuit or circuits or speed negotiation phase transition suppressor circuit or circuits; and
in the event that at least one of the error detection circuit or circuits determines that channel quality is poor and one or more transitions is made from at least one of the data transfer phase or phases to at least one of the speed negotiation phase or phases, at least one of the tone signal transmit select circuit or circuits carries out control so as to prevent transmission of one or more tone signals.

10. A transceiver circuit according to claim 9 further comprising:
one or more receive signal detection circuits; and
one or more timers;
wherein, in the event that at least one of the receive signal detection circuit or circuits and at least one of the timer or timers establish during at least one of the tone phase or phases that at least one receive signal, being absent for not less than at least one fixed time, has been completely disconnected, at least one of the tone signal transmit select circuit or circuits reinitiates transmission of one or more tone signals.

11. A transceiver circuit according to claim 9 further comprising:
one or more cable connect detection circuits;
wherein, in the event that at least one of the cable connect detection circuit or circuits establishes during at least one of the tone phase or phases that one or more cables has been disconnected, at least one of the tone signal transmit select circuit or circuits reinitiates transmission of one or more tone signals after at least one of the cable or cables has been reconnected.

12. A transceiver circuit according to claim 2 wherein:
one or more transmitter power supply control circuits are employed as at least one of the data transfer phase transition suppressor circuit or circuits or speed negotiation phase transition suppressor circuit or circuits; and
in the event that at least one of the error detection circuit or circuits determines that channel quality is poor, one or more transitions is made to at least one of the tone phase or phases, and after at least one of such transition or transitions has occurred, at least one of the transmitter power supply control circuit or circuits causes at least one power supply of at least one transmitter to be turned OFF.

13. A transceiver circuit according to claim 12 further comprising:
one or more receive signal detection circuits; and
one or more timers;
wherein, in the event that at least one of the receive signal detection circuit or circuits and at least one of the timer or timers establish during at least one of the tone phase or phases that at least one receive signal, being absent for not less than at least one fixed time, has been completely disconnected, at least one of the transmitter power supply control circuit or circuits causes at least one power supply of at least one transmitter to be turned ON.

14. A transceiver circuit according to claim 12 further comprising:
one or more cable connect detection circuits;
wherein, in the event that at least one of the cable connect detection circuit or circuits establishes during at least one of the tone phase or phases that one or more cables has been disconnected, at least one of the transmitter power supply control circuit or circuits causes at least one power supply of at least one transmitter to be turned ON after at least one of the cable or cables has been reconnected.

15. A transceiver circuit according to claim 6 wherein:
the transceiver circuit is OP i.LINK-compliant;
one or more TPBIAS mask circuits provided at one or more PORT locations is or are employed as at least one of the speed negotiation phase transition suppressor circuit or circuits; and
in the event that at least one of the error detection circuit or circuits determines that channel quality is poor, one or more transitions is made to at least one of the tone phase or phases, and thereafter at least one of the TPBIAS mask circuit or circuits masks one or more TPBIAS signals from at least one PHY carries out control so as to prevent transmission of one or more long tones and/or one or more continuous signals even if at least one TPBIAS is active.

16. A transceiver circuit according to claim 15 further comprising:
one or more receive signal detection circuits; and
one or more timers;
wherein, in the event that at least one of the receive signal detection circuit or circuits and at least one of the timer or timers establish during at least one of the tone phase or phases that at least one receive signal, being absent for not less than at least one fixed time following transmission of one or more tone signals by one or more local transmit circuits, has been completely disconnected, at least one of the mask or masks applied to at least one of the TPBIAS signal or signals by at least one of the TPBIAS mask circuit or circuits is removed, causing one or more long tone signals and/or one or more continuous signals to be transmitted when at least one TPBIAS is active.

17. A transceiver circuit according to claim 15 further comprising:
one or more cable connect detection circuits;
wherein, in the event that at least one of the cable connect detection circuit or circuits establishes during at least one of the tone phase or phases that one or more cables has been disconnected, at least one of the mask or masks applied to at least one of the TPBIAS signal or signals by at least one of the TPBIAS mask circuit or circuits is removed after at least one of the cable or cables has been reconnected, causing one or more long tone signals and/or one or more continuous signals to be transmitted when at least one TPBIAS is active.

18. A transceiver circuit according to claim 6 wherein:
the transceiver circuit is OP i.LINK-compliant;
one or more TPBIAS suppressor circuits provided at one or more PHY locations is or are employed as at least one of the speed negotiation phase transition suppressor circuit or circuits; and
in the event that at least one of the error detection circuit or circuits determines that channel quality is poor, one or more transitions is made to at least one of the tone phase or phases, and thereafter, even if at least one TPBIAS is active within at least one of the PHY location or locations, at least one of the TPBIAS suppressor circuit or circuits carries out control so as to prevent at least one of the PORT location or locations from being notified of the fact that the at least one TPBIAS is active.

19. A transceiver circuit according to claim 18 further comprising:
one or more receive signal detection circuits; and
one or more timers;
wherein, in the event that at least one of the receive signal detection circuit or circuits and at least one of the timer or timers establish during at least one of the tone phase or phases that at least one receive signal, being absent for not less than at least one fixed time following transmission of one or more tone signals by one or more local transmit circuits, has been completely disconnected, at least one of the TPBIAS suppressor circuit or circuits causes at least one of the PORT location or locations to be notified of at least one value of at least one TPBIAS signal within at least one of the PHY location or locations.

20. A transceiver circuit according to claim 18 further comprising:
one or more cable connect detection circuits;
wherein, in the event that at least one of the cable connect detection circuit or circuits establishes during at least one of the tone phase or phases that one or more cables has been disconnected, at least one of the TPBIAS suppressor circuit or circuits, after at least one of the cable or cables has been reconnected, causes at least one of the PORT location or locations to be notified of at least one value of at least one TPBIAS signal within at least one of the PHY location or locations.

21. A transceiver circuit according to claim 6 wherein:
the transceiver circuit is OP i.LINK-compliant;
one or more BIAS_DETECT suppressor circuits provided at one or more PORT locations is or are employed as at least one of the speed negotiation phase transition suppressor circuit or circuits; and
in the event that at least one of the error detection circuit or circuits determines that channel quality is poor, one or more transitions is made to at least one of the tone phase or phases, and thereafter, even if one or more long tones and/or one or more continuous signals is or are received from one or more remote devices by at least one of the PORT location or locations and at least one BIAS_DETECT is active, at least one of the BIAS_DETECT suppressor circuit or circuits carries out control so as to prevent at least one of one PHY location or locations from being notified of the fact that the at least one BIAS_DETECT is active.

22. A transceiver circuit according to claim 21 further comprising:
one or more receive signal detection circuits; and
one or more timers;
wherein, in the event that at least one of the receive signal detection circuit or circuits and at least one of the timer or timers establish during at least one of the tone phase or phases that at least one receive signal, being absent for not less than at least one fixed time following transmission of one or more tone signals by one or more local transmit circuits, has been completely disconnected, at least one of the BIAS_DETECT suppressor circuit or circuits causes at least one of the PHY location or locations to be notified of at least one value of at least one BIAS_DETECT signal within at least one of the PORT location or locations.

23. A transceiver circuit according to claim 21 further comprising:
one or more cable connect detection circuits;
wherein, in the event that at least one of the cable connect detection circuit or circuits establishes during at least one of the tone phase or phases that one or more cables has been disconnected, at least one of the BIAS_DETECT suppressor circuit or circuits, after at least one of the cable or cables has been reconnected, causes at least one of the PHY location or locations to be notified of at least one value of at least one BIAS_DETECT signal within at least one of the PORT location or locations.

24. A transceiver circuit according to claim 6 wherein:
the transceiver circuit is OP i.LINK-compliant;
one or more BIAS_DETECT mask circuits provided at one or more PHY locations is or are employed as at least one of the speed negotiation phase transition suppressor circuit or circuits; and
in the event that at least one of the error detection circuit or circuits determines that channel quality is poor, one or more transitions is made to at least one of the tone phase or phases, and thereafter, even if one or more BIAS_DETECT signals is active, masking by at least one of the BIAS_DETECT mask circuit or circuits of at least one BIAS_DETECT signal from at least one of the PORT location or locations carries out control so as to prevent at least one of the PHY location or locations from being notified of the fact that the at least one BIAS_DETECT signal is active.

25. A transceiver circuit according to claim 24 further comprising:
one or more receive signal detection circuits; and
one or more timers;
wherein, in the event that at least one of the receive signal detection circuit or circuits and at least one of the timer or timers establish during at least one of the tone phase or phases that at least one receive signal, being absent for not less than at least one fixed time following transmission of one or more tone signals by one or more local transmit circuits, has been completely disconnected, at least one of the mask or masks applied to at least one of the BIAS_DETECT signal or signals by at least one of the BIAS_DETECT mask circuit or circuits is removed, causing at least one of the PHY location or locations to be notified of the fact that at least one BIAS_DETECT is active when the at least one BIAS_DETECT is active.

26. A transceiver circuit according to claim 24 further comprising:
one or more cable connect detection circuits;
wherein, in the event that at least one of the cable connect detection circuit or circuits establishes during at least one of the tone phase or phases that one or more cables has been disconnected, at least one of the mask or masks applied to at least one of the BIAS_DETECT signal or signals by at least one of the BIAS_DETECT mask circuit or circuits is removed after at least one of the cable or cables has been reconnected, causing at least one of the PHY location or locations to be notified of the fact that the at least one BIAS_DETECT is active when the at least one BIAS_DETECT is active.

27. A transceiver circuit according to claim 2 wherein:
the transceiver circuit is IEEE 1394-compliant;
one or more suspend/disable control circuits provided at one or more PHY locations is or are employed as at least one of the speed negotiation phase transition suppressor circuit or circuits; and
in the event that at least one of the error detection circuit or circuits determines that channel quality is poor, at least one of the suspend/disable control circuit or circuits, during at least one of the tone phase or phases, causes at least one PORT at which at least one error is or was detected to enter at least one suspended state and/or at least one disabled state.

28. A transceiver circuit according to claim 27 further comprising:
one or more receive signal detection circuits; and
one or more timers;
wherein, in the event that at least one of the receive signal detection circuit or circuits and at least one of the timer or timers establish during at least one of the tone phase or phases that at least one receive signal, being absent for not less than at least one fixed time following transmission of one or more tone signals by one or more local transmit circuits, has been completely disconnected, at least one of the suspend/disable control circuit or circuits causes termination of at least one suspended state and/or at least one disabled state.

29. A transceiver circuit according to claim 27 further comprising:
one or more cable connect detection circuits;
wherein, in the event that at least one of the cable connect detection circuit or circuits establishes during at least one of the tone phase or phases that one or more cables has been disconnected, at least one of the suspend/disable control circuit or circuits causes termination of at least one suspended state and/or at least one disabled state after at least one of the cable or cables has been reconnected.

30. A transceiver circuit according to claim 2 wherein:
one or more wait states is or are present between at least one of the data transfer phase or phases and at least one of the tone phase or phases; and
in the event that at least one of the error detection circuit or circuits determines that channel quality is poor, one or more transitions is made from at least one of the data transfer phase or phases to at least one of the wait state or states, and only if it is established during at least one of the wait state or states that at least one remote device has been completely disconnected therefrom is at least one transition made to at least one of the tone phase or phases.

31. A transceiver circuit according to claim 30 further comprising:
one or more receive signal detection circuits; and
one or more timers;
wherein, in the event that at least one of the receive signal detection circuit or circuits and at least one of the timer or timers establish during at least one of the tone phase or phases that at least one receive signal, being absent for not less than at least one fixed time following transmission of one or more tone signals by one or more local transmit circuits, has been completely disconnected, at least one transition is made from at least one of the wait state or states back to at least one of the tone phase or phases.

32. A transceiver circuit according to claim 30 further comprising:
one or more cable connect detection circuits;
wherein, in the event that at least one of the cable connect detection circuit or circuits establishes during at least one of the tone phase or phases that one or more cables has been disconnected, at least one transition is made from at least one of the wait state or states back to at least one of the tone phase or phases after at least one of the cable or cables has been connected.

33. A transceiver circuit capable of transferring data at a plurality of transfer rates, the transceiver circuit comprising:
one or more state machines having one or more tone phases in which one or more connections with one or more remote devices are established through exchange of one or more tone signals with at least one of the remote device or devices, one or more speed negotiation phases in which determination of the maximum transfer rate permitted by one or more channels is carried out through mutual notification of one or more transfer rates of which one or more local devices is capable, this notification being actually carried out at at least one of such transfer rate or rates, and one or more data transfer phases in which data transfer is carried out at at least one of the transfer rate or rates determined at at least one of the speed negotiation phase or phases;
one or more error detection circuits detecting one or more errors in one or more receive signals; and
one or more transfer rate comparison circuits comparing the minimum transfer rate of the transceiver circuit and one or more transfer rates employed during at least one of the data transfer phase or phases;
wherein, in the event that at least one of the error detection circuit or circuits detects at least one of the error or errors within at least one of the receive signal or signals during at least one of the data transfer phase or phases when at least one result of at least one comparison made by at least one of the transfer rate comparison circuit or circuits is that at least one of the transfer rate or rates employed during at least one of the data transfer phase or phases is greater than the minimum transfer rate or rates of the transceiver circuit, one or more transitions is made from at least one of the data transfer phase or phases to at least one of the tone phase or phases, and thereafter, the maximum transfer rate of the transceiver circuit during at least one of the speed negotiation phase or phases is set so as to be at least one rate that is lower than at least one transfer rate employed during at least one of the data transfer phase or phases.

34. A transceiver circuit according to claim 33 further comprising:
one or more receive signal detection circuits; and
one or more timers;
wherein, in the event that at least one of the receive signal detection circuit or circuits and at least one of the timer or timers establish during at least one of the tone phase or phases that at least one receive signal, being absent for not less than at least one fixed time following transmission of one or more tone signals by one or more local transmit circuits, has been completely disconnected, the maximum transfer rate of the transceiver circuit during at least one of the speed negotiation phase or phases is returned to its original maximum transfer rate.

35. A transceiver circuit according to claim 33 further comprising:
one or more cable connect detection circuits;
wherein, in the event that at least one of the cable connect detection circuit or circuits establishes during at least one of the tone phase or phases that one or more cables has been disconnected, the maximum transfer rate of the transceiver circuit during at least one of the speed negotiation phase or phases is returned to its original maximum transfer rate after at least one of the cable or cables has been reconnected.

36. A transceiver circuit according to claim 10 wherein the at least one fixed time is not less than 132 ms.

37. A transceiver circuit according to claim 16 wherein the at least one fixed time is not less than 64 ms and not more than 132 ms.

38. A transceiving method substantially effects manifestation of one or more transceiver circuits according to any one of claims 1.

39. A transceiver apparatus comprising:
one or more transceiver circuits substantially according to any one of claims 1; and
one or more external display apparatuses;
wherein, in the event that at least one of the error detection circuit or circuits determines that channel quality is poor during at least one of the data transfer phase or phases or speed negotiation phase or phases, and at least one of the transceiver circuit or circuits is in one or more suppressed states selected from among the group consisting of suppression with respect to transition to at least one of the data transfer phase or phases, suppression with respect to transition to at least one of the speed negotiation phase or phases, and suppression with respect to maximum transfer rate during at least one of the speed negotiation phase or phases, one or more users are notified of such fact by means of at least one of the external display apparatus or apparatuses.
